(19) United States
(12) Patent Application Publication
(10) Pub. No.: US 2007/0226204 A1
(43) Pub. Date: Sep. 27, 2007

(54) Content-based user interface for document management

(76) Inventor: David Feldman, Cambridge, MA (US)

Correspondence Address: BROMBERG & SUNSTEIN LLP, 125 SUMMER STREET, BOSTON, MA, 02110-1618, US

(21) Appl. No.: 11/294,678

(22) Filed: Dec. 5, 2005

Related U.S. Application Data
(60) Provisional application No. 60/639,063, filed on Dec. 23, 2004.

(51) Int. Cl. G06F 17/30

(52) U.S. Cl. 707/5

(57) ABSTRACT

A content-based method of managing a collection of documents is disclosed. A user interface is provided for managing the collection of documents. For each document, at least one information object representative of conceptual content of a portion of the document is identified. The information objects are combined with additional conceptual information inferred from the user interface to determine a network of conceptual relationships associated with the collection of documents. The user interface provides user access to the network of conceptual relationships to manage the collection of documents.

This application claims priority from U.S. Provisional Patent Application No. 60/639,063, filed Dec. 23, 2004, the contents of which are incorporated herein by reference.

### FIELD OF THE INVENTION

The invention generally relates to document management interfaces, specifically, to a content-based user interface for document management.

### BACKGROUND ART

In recent years, electronic mail (email) has become central to communication and collaboration in the workplace. To a large extent it has replaced many older communication technologies such as memos, letters, faxes, and even sometimes face-to-face and phone conversations. It also often serves as a repository for information including files, project plans, task lists, and contact information. Recent research at IDC has found that email is the most time-consuming content task for today's information worker. The breadth and importance of email use has resulted in a dramatic increase in the amount of email with which many workers are faced. Workers need powerful tools for email because they are no longer able to cope with the sheer volume of email they receive. An urgent or urgently needed message may be buried among hundreds of other, less important messages. Yet existing tools fall far short of providing sufficient methods for information management and retrieval.

Email messages are semi-structured documents: They contain some structured information in the form of message headers such as Subject, Date, and Priority. These headers are considered structured because each can be identified by a computer using the consistent, predictable way in which they are placed in the document and tagged with their names. However, the bulk of an email message's content is the text in the message body. This is considered to be unstructured because a traditional computer system (without natural language understanding) cannot identify structure within it.

Traditional email systems base their user interaction on the format of email messages, yet the bulk of a message's content is unstructured. The primary information management and retrieval tools in such systems are thus limited by this:

Browse tools allow the user to interact with a set of choices provided by the system and are typically limited to the message headers. Examples include sorting or grouping a list of messages by sender, date, subject, or another header.

Search tools locate content based on a user-supplied text query and may be used to find instances of specific text in the message body (as well as the headers).

Manual tools allow the user to organize content. The most common example is sorting messages into email folders, which may later be browsed.

There are severe limitations to these methods:

The choices available to browsing tools are limited by the data in message headers and the ability to produce a set of clear choices out of the possibilities for a given header. Candidate headers for browsing typically include date, sender, recipient, and attachment information. While useful, these fail to provide access to any information about the message content. The Subject header may provide some information about message content, but because Subject headers do not use a standard, predictable vocabulary like other headers, their use in browsing is limited.

Search tools require a user to (a) know what information to look for and (b) know how that information is worded. While effective in some situations, this is not ideal in the case of email since the content of unread messages (and even older read messages) is often unknown, and the wording of desired information may be unintuitive to the user since he or she is not the author. Subject headers may be poorly written or indicative of only a portion of a message's content, so finding important content in even a short list of messages may be difficult.

Recent advances in email systems have attempted to address these problems. Apple's Mail.app adds filtering to its search functionality, wherein the list of matching documents is updated dynamically as the user constructs the query. Microsoft Outlook and Mozilla Thunderbird can create groups based on author, subject, date, and other criteria in their message lists, enhancing their browse functionality. Opera's M2 and Mozilla Thunderbird allow storage of custom search criteria, effectively creating “smart” folders. Many systems can organize messages by “thread,” guessing at an ongoing conversation by comparing Subject headers. These improvements are welcome, but remain within the strict boundaries of the email medium's format and do little to address the most critical component of email content: the unstructured message body.

Naturally, the message body is structured from the user perspective. At a semantic level it contains not only words, sentences, and paragraphs but topics, concepts, names of people, places, and things, scheduling information, contact information, and other conceptually distinct objects. We refer to these collectively as information objects or infobs.

Text mining software, such as that available from ClearForest, Insightful, Attensity, Inxight, IBM, SPSS, and SAS, identifies structure in unstructured content, effectively locating the information objects. Such software is already in use in such applications as clustering Web search engines and desktop search tools. Some desktop search tools are able to search a user's email. However, text mining software has not been applied to email (or other similar documents) in a way that avoids the drawbacks of the query/response search paradigm, yet remains accessible to business end users.

Filtering can be applied to a search or browse tool to create more dynamic user interaction. Tools for constructing the search or browse query are presented alongside a view of the result set that is updated as the user edits. Sometimes referred to as a dynamic query, filtering provides immediate feedback about the effectiveness of the user's actions and allows for rapid, iterative refinement. Examples include Spotfire, GRIDL, and NASA EOSDIS, developed at the University of Maryland's Human-Computer Interaction Lab; and faceted navigation systems such as that developed by Endeca Technologies, Inc.

### SUMMARY OF THE INVENTION

Embodiments of the present invention combine the accessibility of a browse tool, the power of a search tool, and the flexibility of filtering, applying these tools to email messages (and similar documents) in their entirety, identifying and using structure in unstructured content via text mining software. The result is a powerful and adaptive set of tools for organizing, prioritizing, locating, and managing information. In effect, it reads your email for you; presents you with a list of items in your email; and provides powerful tools through which those items can be used to locate relevant content.

A representative embodiment of the present invention includes systems and methods for content-based management of a collection of documents. A user interface is provided for managing the collection of documents. For each document, at least one information object representative of conceptual content of a portion of the document is identified. The information objects are combined with additional conceptual information inferred from the user interface to determine a network of conceptual relationships associated with the collection of documents. The user interface provides user access to the network of conceptual relationships to manage the collection of documents.

In further related embodiments, the collection of documents includes at least one partially structured document. The conceptual relationships may include weights representative of relative relationships between the information objects. The weights may be used to sort or filter the collection of documents. The collection of documents can also be sorted or filtered by using the network of conceptual relationships.

Further specific embodiments present on the user interface a document list identifying the documents in the collection and a list identifying the information objects. The list may be a concept list. An embodiment may further provide access to the network of conceptual relationships for filtering. A portion of one of the documents in the collection may be displayed on the user interface, including highlighting at least a portion of the document associated with an information object. The highlighting may be interactive to allow user access to content related to the highlighted portion of the document.

The conceptual content may include at least one of scheduling concepts, task management concepts, and concepts related to personal information management activities. The conceptual content may also include proper names or entities. The documents may include email messages. The identifying of at least one information object representative of conceptual content of a portion of the document may be based on the use of text mining. The network of conceptual relationships may be updated in response to a user action, when the number of documents in the collection changes, or when the content of one or more documents changes.

Embodiments also include a document management system and a document management interface adapted to use the method according to any of the foregoing techniques.

### BRIEF DESCRIPTION OF THE DRAWINGS

FIG. 1 shows one specific embodiment of a Connection Layer.

FIG. 2 shows an example of a document management user interface according to an embodiment of the present invention.

FIG. 3 shows a Document Interface according to an embodiment of the present invention.

### DETAILED DESCRIPTION OF SPECIFIC EMBODIMENTS

Various embodiments of the present invention are directed to techniques for using information objects (“infobs”) to aid in finding, sorting, and filtering documents. Infobs are conceptual elements of a document's content such as phrases, including noun phrases and phrases representing scheduling information; concepts composed of phrases conceptually similar to one another; and proper names of people, places, organizations, or other entities. While most documents contain infobs at a conceptual level, unstructured or semi-structured documents contain many infobs in unstructured content, which most computer programs cannot parse to identify the infobs. Hereinafter the term partially-structured documents will be used to refer to unstructured and semi-structured documents.

Embodiments of the present invention include a user interface for managing and finding such content in partially-structured documents such as email messages; and a system for processing and managing partially-structured documents such as email messages that provides the necessary information—most notably, the infobs—to the user interface. The processing system may include a Text Engine, a Connection Layer, and one or more conventional email processing components.

Embodiments may be useful as part of a system for communicating via text-based documents such as electronic mail. Documents in such a communication system may hereinafter be referred to as “messages” or “emails.” It should be understood, however, that these terms refer to a larger class of document than electronic mail messages, covering any text-based or partially text-based communication over any medium whose content may be processed and presented using the methods described herein (“communication documents”). In some cases, specific attributes of electronic mail messages may be described. The fact that not all communication documents possess these attributes may narrow the scope of applications relating to a particular aspect but does not, by association, narrow the scope of applications relating to any other aspect if such aspect could be applied to the larger class of communication documents or another subclass of it. Examples of communication documents other than email messages include instant messages such as those used by the AOL Instant Messenger and MSN Messenger protocols; shared documents on file servers; messages on online discussion forums; and messages in chat rooms. Examples of documents other than those defined as communication documents that can still use most of the methods described herein include files on a user's computer; pages on the World Wide Web; calendar events, tasks, and other items often included in a personal information management system (PIM); and notes accumulated by the user in a note-taking program.

An embodiment of the invention may operate on a collection of documents some of which are communication documents and some of which are not. Also a “document” may be defined conceptually rather than technically or physically: An email message may be considered a document whether it is stored as a file, in a database, or as part of a larger file containing a message store.

Email systems and other similar document management systems may exist in several configurations. A client program can reside on a user's computer and connect to a traditional server to retrieve documents. In some environments, more functionality is provided by the server. This is particularly true in enterprise systems such as Microsoft Exchange/Outlook and Lotus Notes/Domino. All functionality may also reside on one or more servers and be accessed via a Web browser or other general-purpose client. Embodiments of the present invention may be applicable to any of these configurations and any permutation or combination thereof. Aspects of specific embodiments may reside on a server, on a client, or split between the two. Specific embodiments may be implemented as a standalone client or client/server product, or may be integrated into or developed as a plug-in for a preexisting product.

Various embodiments are based on a text mining component (a “Text Engine”) such as one of those available for license or purchase from several companies including ClearForest, Insightful, Attensity, Inxight, IBM, SPSS, and SAS. The Text Engine scans documents and identifies infobs in them. Specifically, it may extract phrases and entities; combine entities and phrases into larger conceptual objects (“infobs”) based on similarity (so, for example, two phrases with similar meanings but different wording may be combined); provide a weight for each object indicating its importance in the document and/or document collection; update objects and their weights as documents are added to or removed from the collection; and/or provide an interface by which the invention may obtain the position of each object's constituent extracted elements in each document.

It may be advantageous to determine several categories of infob. Infobs may represent people; organizations, such as a company; places, such as a country or city; scheduling infobs, for example based on phrases such as “Wednesday at 2 pm”; or concepts. Concepts are as much a conceptual category as a technical one, referring (roughly) to anything that might be a topic or sub-topic. Concepts may include any infobs based on non-entity phrases such as noun phrases. A concept may be defined as any infob not explicitly put in another category (possibly with some explicit exceptions). Certain definable categories may be included as concepts, such as places and organizations, due to their similarity from a user's perspective. The exact definition may also depend on the Text Engine. Concepts are related to the invention's functionality in that they provide valuable information about the subject matter of documents. The Text Engine may also extract mood or sentiment. Some available Text Engines may be modular or may provide only part of the necessary functionality. It may be possible to combine such engines or elements thereof to achieve the functionality needed.

A Connection Layer may track relationships among infobs and other objects in the system such as documents; or user- or system-defined labels or tags, such as folders similar to those found in many existing email systems. The Connection Layer may be stored as a network of nodes with one node per object.

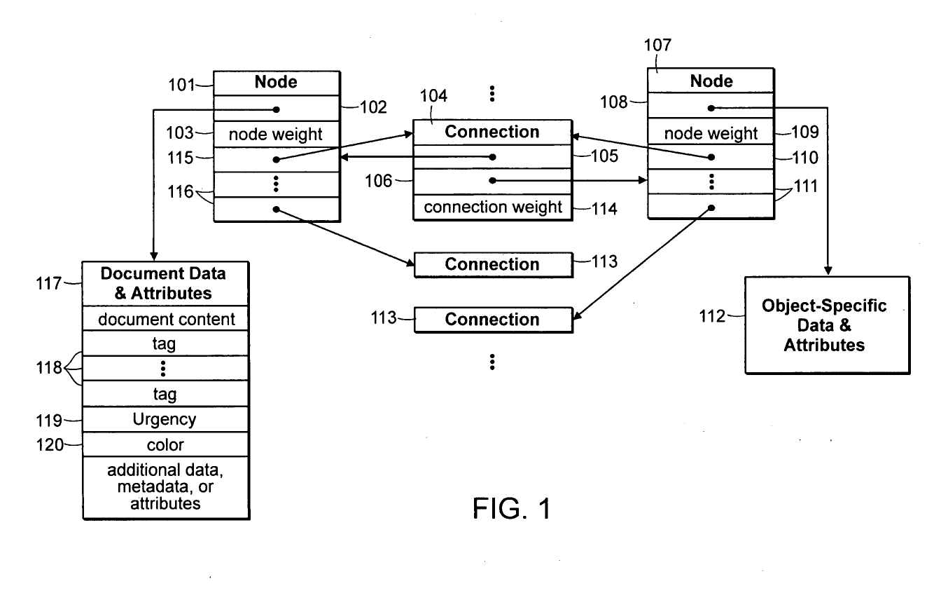

FIG. 1 shows one specific embodiment of such a Connection Layer. Each node (101, 107) is a data structure containing data and other information specific to the object represented by the node, or a pointer (102, 108) to such data (117, 112); a weight value (103, 109); and a set of connections to other nodes (104, 113 with pointers 115-116, 110-111). In the subsequent discussion, the terms “node” and “object” may be used somewhat interchangeably: “node” will be understood to refer both to a node and to the object it represents, and “object” will be understood to refer both to an object and to the node that represents it. When the distinction between the two is important, it is made explicit.

A connection connects two nodes. A connection may be stored as a data structure (104) containing a pointer to each node in the connection (105, 106), and a connection weight value (114). Connections may be commutative (bidirectional). Conceptually, every node may be connected to every other node by exactly one connection. Where a connection's weight is 0, the data can be simplified by not storing that connection. A node's connections may be stored as an array of pointers to the relevant connection structures (115-116, 110-111).

The connections in the Connection Layer may be stored in a single, global array whose values are connection weights. Each node stores two arrays for its connections: A node array O, each of whose values is a pointer to the other node in the corresponding connection, and a weight array W, whose values are indices in the global connection array and whose indices correspond to those in O. Thus for any node X, for each valid index i, X is connected to another node O[i] by a connection with weight W[x]. This embodiment, while more complex, may be more lightweight.

The simple node-connection network described above may be expanded into a full neural network or other adaptive complex system. This may yield further benefits in terms of system adaptability.

A non-document node is said to be assigned to a document if that node has been attached or connected directly to the document, either by the user or by the system. There are multiple mechanisms by which this might be accomplished. Most involve storing a pointer or identifier for the node with the document; storing a pointer or identifier for the document with the node; or both. A phrase-based object may be assigned to a document if one of its constituent phrases occurs in the document. A folder or tag may be assigned to a document if it has been explicitly assigned by the user or automatically assigned by the system.

A node may be created in the Connection Layer for each document (101) and other nodes assigned to it via connections. This may provide a more unified data structure. It also allows an object to be assigned to a document with an assignment weight, using the weight value of the connection between the document and the object (114) (see the subsequent discussion of connection weights). This allows storage of more information regarding the relationships between documents and other objects, and may be beneficial in several situations.

For example, an infob may be assigned to a document from which it has not been extracted or otherwise identified by the Text Engine, such as a document that is part of a Conversation to one or more of whose constituent documents the infob has been assigned. Under such circumstances a lower assignment weight may be appropriate. Assignment weight may also be based on an infob's prominence or importance in the document, as determined by the Text Engine; the number of occurrences of constituent phrases within the document and/or their distance from the start of the document; the existence and position of constituent phrases within certain parts of the document, for example the header fields in an email; or some other calculation.

The association between two objects is a measure of the degree to which they are conceptually related. This relationship is determined differently for different types of object, and specific methods for making that determination are discussed subsequently. Association may be stored as an explicit value or may be calculated from its component elements as needed. Implementation of assignment weights (for example, through inclusion of documents in the Connection Layer) may be particularly helpful in calculating accurate association values. Assigning a non-document object to a document may generally create a strong association between them, strong enough for a search based on the non-document object to produce the document.

A node weight is a value (103, 109) that represents the importance of the object represented by a node. A node's weight may initially be determined from the weight value generated by the Text Engine for the corresponding infob, or set to a neutral value when that information is unavailable. In an embodiment, the weight is increased for infobs found in the Subject header of an email message or other document for which such structured information is available. The text of the infob or its constituent phrases may be used to compose a search query of the document collection, and the result may also help determine the initial node weight.

Node weights can be adjusted over time based on input from the Text Engine and user interface. For example, when the Text Engine changes its weight for an object, that change may be reflected in the node weight. The node weight of a node A may be increased based on “positive” user actions such as clicking on or otherwise selecting or indicating A or an object of sufficient association with A; viewing a document of sufficient association with A; taking an action that explicitly increases the association between A and another object with a high node weight, such as explicitly connecting them; implicitly increasing the association between A and another object B of high node weight such as by explicitly assigning A to a document to which B has already been assigned, or by explicitly connecting A or an object C with which A is sufficiently associated with B or with another object D with which B is sufficiently associated; taking an action that explicitly decreases the association between A and another object with a low node weight; implicitly decreasing the association between A and another object of low node weight; or replying to or forwarding a document sufficiently associated with A.

The node weight of A may also be decreased based on “negative” user actions such as deleting a document sufficiently associated with A; deleting a document sufficiently associated with an object sufficiently associated with A; deleting a non-document object sufficiently associated with A; taking an action that explicitly increases the association between A and another object with a low node weight; implicitly increasing the association between A and another object of low node weight; taking an action that explicitly decreases the association between A and another object with a high node weight; implicitly decreasing the association between A and another object of high node weight; or overriding the result of an automated action taken by the system.

Adjustments to node weights such as those described above may be temporally informed, i.e. may depend on when the triggering actions or events occur. For example, viewing a document is likely to be considered a “positive” user action, but the degree to which it is “positive” may depend on how soon after the document arrived it is viewed and/or for how long it is viewed.

A connection's weight is a value (114) that indicates how strongly connected its two nodes are. A connection weight of 0 indicates no significant connection between the two nodes, and some embodiments do not store such connections. For a new node A, the initial connection weight S with a node B may be determined from the number of documents M to which both objects are assigned, and/or the weights of already-established connections between A and other nodes and between B and other nodes. Once the connection exists, S may be continuously or periodically adjusted based on changes to M; other changes in the Connection Layer—for example, an increased connection weight between a node connected to A and a node connected to B or, more generally, an increased association value between a node sufficiently associated with A and a node sufficiently associated with B; user actions, such as explicitly or implicitly connecting A and B in the user interface; or explicitly setting or adjusting S via a user interface designed to allow such action. An embodiment may only allow zero or positive connection weights. Other embodiments may permit negative connection weights representing an active dissociation between two objects.

The connection weight between any two objects contributes significantly to their association. Adjustments to a node's weight may propagate across connections to adjust the weights of connected nodes. Such propagated adjustments may be proportional to the weights of the connections between the nodes, and may decrease in significance proportional to the distance from the original node, measured in number of connections.

Two objects are indirectly connected when one may be reached by following two or more nonzero connections from the other. The strength of an indirect connection may be calculated from the weights of the connections followed, proportional to the distance (measured in connections). This strength may in addition be proportional in part to the node weights of intervening nodes. The strength of indirect connections between objects may contribute to association.

When two objects are sufficiently associated and that association is primarily due to one or more indirect connections, the weight of their direct connection may be increased. Information about this link between the direct and indirect connections may be stored so a subsequent decrease in the indirect connection can result in a decrease in the direct connection. When a document and another object are sufficiently associated the object may be explicitly assigned to the document by the system. Information about this link between the association and the assignment may be stored so a subsequent decrease in the association value can result in a removal of the assignment. However, in an embodiment that uses the Connection Layer for assignment, there may be no need for a functional distinction between an assignment and a strong connection.

An embodiment stores an Urgency value for each document (119), used to indicate document importance and/or priority. This value may be determined from one or more of the following factors: metadata associated with the document indicating importance, priority, or urgency, such as the Priority header on email messages; sentiment (mood) determined by the Text Engine; scheduling infobs in the document, combined with document date information to produce an absolute date; the weights of sufficiently associated nodes, proportional to the degree of association; and the Urgency values of sufficiently associated documents, proportional to the degree of association. Some mathematical transformation may be required to convert a Text Engine's sentiment value to one that can be used by an urgency calculation. For example, a Text Engine might provide sentiment on a scale from −1 (very bad) to +1 (very good), with 0 being a mood-neutral message. Since urgency is dependent on strength of mood but not necessarily quality, the absolute value of the sentiment value might be used instead of the value itself.

In embodiments involving communication documents, a group of documents may be further defined as a Conversation, based on some or all of: similar document metadata such as Subject headers; similar date information; similar content (particularly quoted content in email messages); and similar recipient lists and/or senders. A Conversation is likely to represent an ongoing discussion, and can be presented to users and used to improve Connection Layer performance. Joint membership in a Conversation may increase the connection weight between documents in an embodiment that supports this. Conversations may be stored as objects in the Connection Layer. Each Conversation may store pointers or other identifiers for its constituent documents. An embodiment stores Conversations as non-node objects, in which case a Conversation may maintain its constituent documents via pointers to the appropriate document-specific data objects (i.e. 117), and a document may reference the Conversations of which it is a part via pointers to the appropriate Conversation objects.

Conversations may be stored as nodes, allowing them to participate in the relationship-managing properties of the Connection Layer, and the relationship between a document and a Conversation may be stored using a connection. Since it may be appropriate to maintain such a relationship as a binary one, such a connection's weight may only be either 0 (the document is not part of the Conversation) or the maximum connection weight value (the document is part of the Conversation). The number of Conversations with which two nodes are both associated and the strength of those associations may be used in initially determining and then adjusting the weight of the connection between them.

Conversations may also be used to assign objects to documents with little content of their own. For example, it is not uncommon for an email message to contain a concise reply to a question without further content and, most importantly, without the text of the original question. However, if such a document is determined to be part of a Conversation, the weights of its connections with objects associated with other documents in the Conversation may be increased.

The membership of two documents in a Conversation may contribute to the association between them. Sufficiently strong associations between two nodes and one or more documents in a Conversation may contribute to the association between the nodes.

Attributes of the document type can be used to improve Connection Layer performance further. For example, email signatures and quoted messages may be identified and either removed or decreased in emphasis when passed to the Text Engine. This prevents text, repeated due not to importance but to the structure and conventions of the medium, from inappropriately increasing the weight of certain nodes. In another example, common business terms (such as “meeting” or “milestone”) may be identified explicitly to improve the. Text Engine's extraction and classification of them or related phrases.

Multiple document types may be used in some embodiments, for example, email messages and notes. Notes are documents created by the user that may have the same types of content as email messages but lack some of the header information and may not be sent to others. Notes may be converted to messages by the user.

Certain tags may be assigned to documents (118) to indicate information about them. A tag is a binary flag whose value may indicate the presence or absence of a document state, document type, or other attribute. Tags may be categorized into Descriptor Tags and Type Tags. Descriptor Tags include Flagged, indicating that the user has “flagged” the document for future reference; and Unread, indicating that the user has not viewed the document since it arrived or has explicitly re-applied the tag after viewing the document. Type Tags include Queued, identifying an email queued to send; Draft, identifying a stored outgoing email in progress; Sent, identifying an email the user has successfully sent; Sending, identifying an email in the process of being sent; Send Error, identifying an outgoing email for which an error has occurred in the processing of sending; and Deleted, identifying a document scheduled for deletion.

Folders may be assigned to documents to categorize them. Folders, in some form, are familiar to most email users and are part of most email systems, but their implementation varies across products. One or more folders may be assigned to a document. This calls into question the use of “folder” as an appropriate term, but it may be the best term due to user familiarity with it. Another possibility, used by Google's Gmail for a similar feature, is “label.”

Folders may be implemented in a manner somewhat similar to tags: A collection, such as an array, is maintained for each document, containing an identifier for each folder assigned to the document. The folder name may be the identifier, but since the user may rename a folder a permanent identifier such as a unique folder ID may be preferable. Folders may be considered as objects in a way that tags may not be, and each folder may be stored as a node in the Connection Layer. In an embodiment that stored documents as nodes in the Connection Layer, folders may be assigned to documents via connections. Since folder assignment may be binary (a document is either assigned to or not assigned to a folder), it may be appropriate to use the only the maximum connection weight for folder assignments (or a connection weight of 0 where no folder assignment exists), effectively bypassing connection weights altogether.

Each document may have exactly one primary folder and zero or more secondary folders stored via a method similar to the foregoing. Documents not assigned to any folder may use a default Unassigned folder, which may not be presented in the user interface, as their primary folder. Additional information may be stored with the document designating which folder is the primary folder. Such an arrangement may be useful in an embodiment implemented to interoperate with or as part of a system that itself only allows one folder per document and may store documents in their folders instead of as part of a unified document store. It may also be useful in an embodiment that implements its own server component, to allow access by traditional email client programs. The user interface may still operate as though messages were part of a unified document store. In some embodiments, folders can be implemented as a hierarchy: A folder may be defined as a sub-folder of another folder.

Search is a common process for locating information in which the user specifies a query composed of one or more search terms (usually words or phrases), after which a search engine locates content (the search result) based on the query. Terms are typically combined using the AND operator but other operators, as well as other tools, may be used to structure the query. To conduct an effective search, the user must know at least one search term describing the content he seeks, and thus must know something about the desired content. While it is possible to refine a search after seeing the search result, search is not by nature an iterative process.

An embodiment employs a primarily browse-based filtering method, hereinafter referred to simply as “filtering”. Filtering, while not a complete substitute for search, addresses some of search's shortcomings. The user constructs a query by selecting from among candidate terms presented by the filtering system. The filter result and candidate terms are presented simultaneously. An initial filter result, containing all possible documents or a subset based on an initial base query, is presented prior to any user term selection. (Such an initial filter result will hereinafter be referred to as a Base Filter Result.) The filter result is updated after every term selection, de-selection, or other modification by the user, creating an iterative process in which the user receives immediate feedback for his actions. The iterative nature of the process makes it a more flexible and dynamic approach than search. The presence of candidate terms obviates the need for the user to know what to search for, making it a more appropriate information-seeking process in many situations, in particular those in which the user's knowledge of target documents is limited. Filtering is similar in a number of ways to faceted navigation such as that provided by Endeca Technologies Inc. Embodiments of the present invention differ most notably in their application to partially-structured content, as well as in implementation details and user interaction.

A candidate term is any object known to the system that may be presented to the user and selected for inclusion as a term in the filtering query. Candidate terms include infobs and folders. A filter set is a filtering query. It is composed of all selected candidate terms; all text strings defined in elements allowing inclusion of a user-defined text string as a filtering term; and any other filtering terms defined by the user or the system, and combined by operators defined by the system, the user, or a combination thereof. The filtering process may be understood as a series of steps in which the filter set is refined to the user's satisfaction, producing an ever more relevant document set.

A document set is a set of documents displayed in the Main Interface or in another user interface that allows the display of one or more documents. A document set may be produced by a filter set as the set of documents that match the filter set. A search may also produce a document set, as may other actions. In one specific embodiment, the Main Interface and every other interface described herein may have exactly one document set and either zero or one filter set at any given time, though multiple instances of the Main Interface or another user interface may exist simultaneously, each with its own filter set and document set. While a document set may be defined by a process other than filtering, an embodiment of the Main Interface has a document set that always reflects its filter set. This may be achieved via specialized user interface elements such as the “Custom Search“or “Last Search” View described below.

A filter set may produce a document set as follows. For each term in the filter set, a single-term filter result is the set of documents that match the term. The document set may then be composed by combining all its single-term filter results according to the operators with which the terms are combined. The most common operator, AND, results in the intersection of single-term filter results. While the foregoing provides a definition of a document set, it may not be the most efficient way to determine such a document set. The determination of whether a term matches a document is made irrespective of other terms in the filter set. A document matches an object if the association between them is above a certain globally-defined threshold. Methods by which a document may match a non-object term are described hereinafter.

Alternatively, associations may not be used in determining a match, and instead, a document matches an object if and only if the object is assigned to it. If assignment weights are used, an object matches a document if and only if the object is assigned to it with an assignment weight above a threshold value.

An alternate definition of a document set first matches documents to a set of filter terms as a single unified step, generating a multi-term filter result. The terms used for this multi-term filter result may be all terms in the filter set or may be only some terms, for example all terms created from candidate terms; all terms that correspond to objects in the Connection Layer; or all terms that correspond to infobs. Single-term filter results are then generated for all remaining terms as described above. The multi-term and single-term filter results are then combined based on the operators between them, as described above. The unified match generating the multi-term filter result may be accomplished, in a simple example, through the use of a globally-defined average threshold. A document is included in the resultant multi-term filter result if the average of its associations with all terms under consideration exceeds this threshold. In an embodiment, only terms combined with AND are included in the multi-term filter result calculation.

Alternatively or in addition, search features in the Text Engine, from a separate vendor, or implemented as part of the invention (for example, using or based on known search algorithms) may be used to generate the document set; or to generate some number of single-term or multi-term filter results, which may then be combined with each other and/or with remaining terms via the method described above or via a function provided by the Text Engine or another search facility.

Combinations of two or more of the foregoing techniques may also be used to determine a document set. For example, a facility in the Text Engine or a search facility supplied by another vendor may be used as described above; a method for using associations to determine a document set may also be used, such as those described previously; and the results of these two methods may be combined by intersection, union, or a more complex process such as choosing the most relevant documents from each set for inclusion in the final document set, where relevance may be internally defined in the former case and defined by association values in the latter.

Search functionality using a more traditional query-response process may also be used. This may be combined with filtering, using a search to define a Base Filter Result (via the “Custom Search” View described below) and then filtering to refine it further. Some Text Engines provide the capability to use a document or group of documents as a query. An embodiment that includes such a Text Engine may also include a Find Similar command that performs a search using the documents selected in the Document List of the active user interface as the query.

A string search facility may be included in the filtering system itself, allowing the user to type a phrase or phrases to be used as a term in the filter set via a search for them in the document collection. Documents may be determined to match this string search based on search functionality included in the Text Engine, search functionality provided by another vendor, or by a string search function implemented as part of the invention, either with or without fuzzy matching functionality. By default, this term is combined with the rest of the filter set using the AND operator.

The effectiveness of a filtering system rests largely on the appropriateness of the candidate terms and the clarity of their presentation. The aforementioned processes and data structures including infobs, folders, a Text Engine, and/or a Connection Layer may be used to determine how terms and documents relate, and to identify, categorize, and prioritize candidate terms for presentation to the user in a dynamic manner. A number of user interface elements may be employed to present candidate terms in a clear, intuitive, and familiar way, as described below.

In an embodiment that does not use a Connection Layer, each infob identified by the Text Engine may be a candidate term. Such candidate terms may be categorized by type of infob. Possible term categories include people, organizations, concepts, and scheduling infobs. Terms may be prioritized using importance scores (weights) generated by the Text Engine; one or more of the other factors a Connection Layer would use to calculate node weight; or a combination of these. Much of the subsequent discussion assumes the presence of a Connection Layer, and refers to its node weights. An embodiment without a Connection Layer may simply substitute one or more of the foregoing.

Each non-document object in the Connection Layer may be a candidate term. (In an embodiment with a Connection Layer, infobs identified by the Text Engine are may not be used directly as candidate terms since a node exists for each in the Connection Layer.) Such candidate terms may be prioritized based on their node weights. Such candidate terms may be further prioritized based on the node weights of associated or connected nodes, proportional to the association values or connection weights.

Folders may be candidate terms. Since folders are user-defined, it may be appropriate to present all folders at all times. Folders may be presented in alphabetical order rather than in order of importance, so prioritization of folders may not be necessary. Certain folders may be omitted at certain times and/or folders may be sorted by importance. A given folder may be prioritized using its last-viewed date; its last-modified date; number of items; the date on which an email was last received from or sent to senders or recipients of emails in the folder; the date on which an email in the same Conversation as one in the folder was last received, sent, and/or viewed; the node weight of the folder in the Connection Layer; the node weights of nodes associated with the folder in the Connection Layer, proportional to the association values; the degree of association between the folder and documents in the document set; or a combination of these factors.

Tags may be candidate terms. Tags may be presented for use as candidate terms via a user interface element that allows the user to select one or more tags, or indirectly through another user interface element such as the View List described hereinafter. An embodiment that implements such indirect access to tags as candidate terms may still provide direct access through a search or advanced filter tool. A document matches a tag if that tag has been applied to the document (i.e. the associated flag's value is I or true).

Urgency values may be candidate terms. Embodiments that include user interface elements to present Urgency values as candidate terms are described hereinafter. A document may match an Urgency value if its Urgency value is equal to that value. Alternatively, a document may match an Urgency value if its Urgency value represents greater urgency (i.e. higher priority) than that value; or represents urgency greater than or equal to that value. An embodiment may support one or more of these methods of matching.

In an embodiment involving structured or semi-structured documents, the possible values for any document field (such as a header field in an email message) with a predictable or categorizable set or range of values may be candidate terms. For example, potential values or ranges of values for a date field may be candidate terms. Embodiments that include user interface elements to present Date values as candidate terms are described hereinafter.

In an embodiment involving communication documents, attachment file types may be candidate terms. For example, the user might add a “Microsoft Word attachment” candidate term to the filter set to restrict the document set to documents with a Microsoft Word file attached.

Specific embodiments of the user interface may be implemented on a variety of platforms, including any major computing platform available today. These include any version of Microsoft Windows (including those designed for use on handheld devices); Linux, BSD, UNIX, or another UNIX-like operating system, with or without a graphical environment such as X Windows; Mac OS, including Mac OS 9 and Mac OS X; and any of a number of popular Web browsers, including Microsoft Internet Explorer, Mozilla, Firefox, and Safari, running on any operating system that supports it. Some of these environments are graphical in nature, while some are not. Some provide more interactivity than others. The following description is based on a graphical environment such as that provided by Microsoft Windows, Mac OS X, or X Windows running on a typical desktop or notebook computer. However it should be understood that the invention may be implemented in a less interactive, less graphical, or even purely textual environment, and on a variety of devices including tablet computers, handheld devices, and mobile phones. Such platforms may require the substitution of one user interface element for another but can generally make that substitution without invalidating the basic user interaction.

The user interface elements used by embodiments of the present invention are already part of many popular computing environments and can be implemented in other environments that do not already possess them. Their exact nature may vary depending on the operating environment in which the invention is implemented. The following descriptions favor elements arranged visually on a display, but the elements may be adapted to another medium.

A list box is an element that can present several items simultaneously, generally by displaying them in a vertical column. An item's data is commonly textual but may also be graphical, of another data type, or of a combination of data types. Items may be selected by the user, and that selected state is reflected by the element. In an embodiment, only one item may be selected at a time. In another, multiple items may be selected. In an embodiment, information other than the primary data may be provided for each item, for example by the presence and/or appearance of one or more images (icons), or by a change in overall appearance (such as displaying part or all of the item's content in gray to indicate a disabled or partially disabled state). Each such non-data informational item is referred to as an attribute, and a list box may have any number of attributes.

A multi-column list box is a list box that can display several distinct fields of data for each item. This data may be textual, graphical, of another data type, or of a combination of data types. The user may be able to re-sort the list by any field. In traditional graphical environments, a multi-column list box is typically represented by a list box with several columns. Sorting is typically accomplished by clicking in the column header. When displayed graphically, a multi-column list box typically shows a single row for each item. However, a list box may include additional rows for an item. A field in such a list box may span more than one of another row's columns. One embodiment includes a primary row, which contains most of each item's data and with which the column headers correspond; and one or more secondary rows, whose field or fields span several of the primary row's columns.

A dropdown is an element that in its normal state presents one item, selected from a list of items. An item's data is commonly textual but may also be graphical, of another data type, or of a combination of data types. The user may reveal the list and make another selection, after which the new selection is presented in place of the old one. A text input box is an element that allows the user to enter a string of text. A content box is an element that can present content to the user, such as the contents of a document. In a graphical environment, a content box may display unformatted text (plain text), formatted text, graphics, or a combination of text and graphics such as that found in a Web page or HTML-formatted email message. A tool tip is an element that provides context-sensitive help or documentation for a particular element in an interface. In traditional graphical user interfaces, a tool tip is implemented as a box that appears when the cursor pauses over its associated element.

A menu or pull-down menu is an element that normally presents only its title. The user may activate the menu (for example, by clicking on it) to reveal a list of options. Selecting an option may initiate a command or change a setting associated with that option. Menu options (also known as menu items) may be disabled, present an attribute to indicate an on/off state, present attributes similar to those found in list boxes, and/or provide an equivalent keyboard command. Menus are standard in today's graphical interfaces, and are generally found either at the top of a window or at the top of the screen, collected in a menu bar. A pop-up menu is a standalone menu that may be found outside a menu bar.

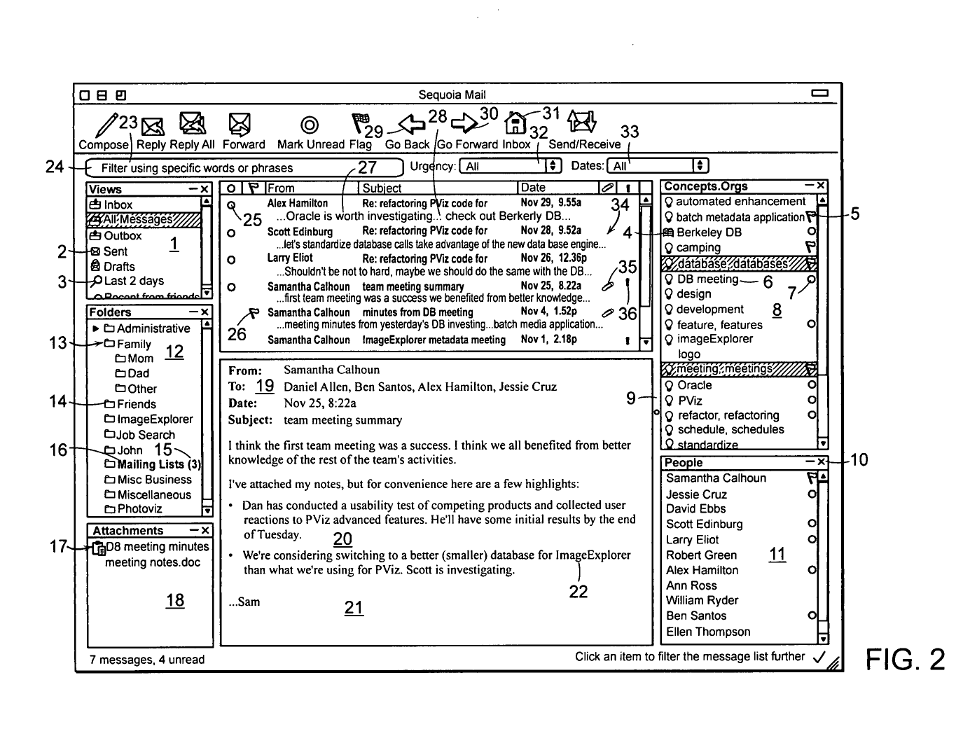

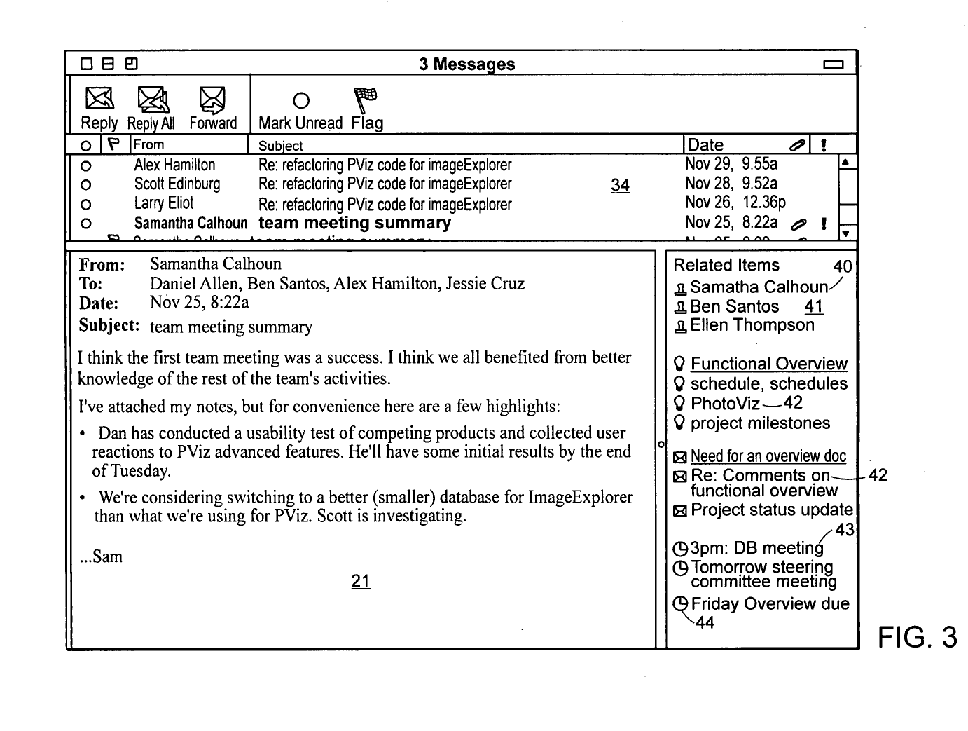

An embodiment of the user interface includes a Main Interface (FIG. 2), where most activity occurs, and may also include several auxiliary user interfaces for certain activities. These may include a Compose Interface, a Document Interface (FIG. 3), a User Preferences Interface, several interfaces for managing mail rules, and other auxiliary interfaces. Each is composed of several elements. Any of these elements may permit the user to rearrange or hide them. For example, the pair of buttons 10 in FIG. 2 allow a user to hide or minimize the element of which they are a part. Elements may also permit the user to resize them, as appropriate. For example, splitter bar 9 is a user interface element that allows the user to resize the elements on either side of it.

A View defines an initial filter set, used to produce a Base Filter Result. The user begins or resets a filtering session by selecting or re-selecting a View. The user may define a View by executing a command that creates a View out of the filter set. The user may also define a View after performing a search by executing a command that creates a View out of the query. The same command may be used in both cases or a different command may be used for each. The user may change a View's name as part of the command that creates it, at a later time, or both.

An embodiment may further include one or more predefined Views, or Special Views. Some possible Special Views include: A View with no query attached, whose corresponding filter result is thus all documents, and which may be named “All Documents” or “All Messages”; a View excluding documents to which a folder or Type Tag has been assigned, which may be named “Inbox” in an email-based embodiment, as it mimics the functionality of the Inbox folder in a traditional email system; a View including only documents with the Queued tag, which may be named “Outbox”; a View including only documents with the Sent tag, which may be named “Sent”, “Sent Messages”, or “Sent Mail”; a View including only documents with the Draft tag, which may be named “Drafts”; a View including only documents with the Deleted tag, which may be named “Deleted”, “Deleted Messages”, or “Trash”; and a View representing a Base Filter Result derived from an action outside the filtering system, for example from a search, which may be named “Custom Search” or “Last Search”. This last View may only be present when appropriate.

In some embodiments, some Special Views may be particularly important to the operation of the user interface, including several of those listed previously as examples. Due to their importance, the user may be prevented from deleting or editing one or more such Special Views, or may be permitted to edit only certain aspects of one or more such Special Views. For example, a user might only be permitted to provide a range of document modification or receipt dates for a particular Special View, outside of which documents would not be displayed.

Views may be presented in a list box, the View List (FIG. 2.1), included in the Main Interface of some embodiments. In an embodiment it supports only one selected item at a time. In an alternate embodiment multiple items may be selected, in which case the Base Filter Result is produced from a query or filter set constructed by combining the selected Views with the AND or the OR operator. An embodiment of this uses the OR operator by default. The View List may support presentation of an attribute indicating the type of View, i.e. user-defined, Special View, a particular class of View, or a particular individual View such as the “Custom Search” or “Last Search” View described above. In an embodiment, this attribute is displayed as an image next to the item text (2, 3).

Selecting or re-selecting an item in the View List may reset the filtering system, de-selecting any candidate terms previously selected and resetting any other filtering options to their default values.

A Filter List is a specialized list box used for filtering. In an embodiment, it supports multiple selected items. A further embodiment sorts Filter List items alphabetically. A Filter List may present a “category” attribute for each item, indicating the type of information represented by the item. In an embodiment this attribute is displayed as an image to the left of the item text (4). It may also present a “status” attribute for each item, used to indicate additional status information. In an embodiment this attribute is displayed as an image to the right of the item text (5). It may present a binary “relevance” attribute for each item, indicating whether the item is relevant to the current document set. In an embodiment this attribute is presented by displaying relevant items normally and non-relevant items with their text (6) and possibly other attributes (7) in gray. In an alternate embodiment, this attribute could be continuous rather than binary. One such embodiment displays item text using a range of colors between normal display and a light gray to indicate a range of values. In an embodiment, a Filter List may have an “urgency” attribute, used to indicate document Urgency. An embodiment in a graphical environment displays this attribute as an icon near the “status” attribute.

A Filter List may be used to present one or more categories of candidate filter term. When more than one category is displayed, the “category” attribute may be used to differentiate among them. An embodiment of the invention provides a default set of Filter Lists presenting a default set of candidate term categories. A further embodiment allows the user to choose how many Filter Lists will be presented and which term categories each will present. In one embodiment, a Filter List will only present its “category” attribute when it contains more than one term category. One embodiment provides three Filter Lists by default: a Folder List containing folders; a People list containing people; and a Concept List containing concepts, organizations, places, and scheduling infobs. An alternate embodiment assigns to this Concept List all term categories not explicitly assigned to another Filter List. Such an embodiment may allow the user to disable this behavior, potentially omitting some types of term entirely.

In an embodiment involving communication documents, the “status” attribute on each Filter List item may be used to indicate the presence or absence of certain tags on documents that match the item. In an embodiment, the “status” attribute indicates the presence of the Unread or Flagged tag. In one such embodiment, a different image is displayed to indicate each, while no image is displayed to indicate the absence of both. In such an embodiment one tag may take precedence over the other for presentation by the “status” attribute if both are present. In one embodiment the Unread tag takes precedence. In a further embodiment, the user may choose which tag takes precedence. In an embodiment, the “status” attribute is displayed in gray when the “relevance” attribute causes the item text to be displayed in gray.

In an embodiment, an “urgency” attribute is used to indicate items assigned to documents with high Urgency values. The attribute may be used in a binary manner, or may use several states to indicate several values. For example, in a graphical environment a red image might indicate a very high Urgency, an orange image a fairly high urgency, and no image anything else. The state of the “urgency” attribute may be determined from the document with the highest Urgency value that matches the item. In an alternate embodiment, one of these techniques is applied instead to the “status” attribute, in addition to the functionality already described for that attribute. In such an embodiment, a sufficiently high Urgency value may take precedence over the presence of one or both of the other tags presented by the “status” attribute, or one or both of the other tags (when present) may take precedence over Urgency values.

At times there may be candidate terms that do not match any document in the current document set. The non-relevance of such items may be presented to the user via the “relevance” attribute of the Filter List. Adding such a non-relevant item to the filter set would result in an empty document set. Accordingly, the filtering behavior may be modified in this case so that selecting such an item resets the filter set back to the selected View before adding the new term to it. Since the term may also have no match in the document set defined by the View, the resulting document set may still be empty, but it is less likely to be. In an alternate embodiment, the View may be changed to the “All Messages” Special View under those circumstances, guaranteeing a non-empty document set. If the action that selects such a non-relevant item is a secondary or “advanced” action (i.e. an action other than those actions used in basic selection of items), the filter reset described above may not occur. In one embodiment, the filter reset action does not occur when the action that selects the non-relevant item is performed on a list that permits selection of multiple items, when one or more items are already selected in the list, and when the action that selects the item is one that adds the target item to the set of selected items.

A Filter List contributes its selected items to the filter set of the user interface of which it is a part. In an embodiment, these items are combined with each other and with other terms in the filter set using the AND operator by default. The user may elect to use another operator, such as NOT, for any individual term. This option may be accessible via a secondary action such as a right-click context menu. In an embodiment that allows this, the chosen operator may be presented to the user via an additional attribute in the Filter List. In such an embodiment, the attribute may be only used when an operator other than the default is chosen, or when the default operator is chosen in an explicit rather than an implicit manner (via a command that makes the operator explicit). Note that in the filtering process as described herein, the OR operator may not be useful, since documents are included in the document set by default. An alternate embodiment starts with an empty document set and adds terms to the filter set using OR as a default operator.

An embodiment allows nesting and grouping of terms in the filter set. However, an embodiment leaves such advanced query construction to a search feature to maintain the simplicity of the filtering process.

An embodiment sorts Filter Lists alphabetically. Other embodiments may employ other sorts for one or more Filter Lists, including sorts by node weight (importance), relevance to the current document set determined through association values, another criterion, or a combination of criteria.

Individual Filter Lists may vary in their behavior based on user preferences or design decisions based on peculiarities in a particular category or categories of candidate term. For example, a Filter List may have a potentially large set of candidate items, more than can be presented effectively at one time, particularly given an alphabetical sort. There may also be candidate items whose importance to the user is questionable, for example those that appear in only one unimportant document or those that appear frequently enough to be uninteresting. It may thus be advantageous to limit the length of a Filter List.

The length of a Filter List may be limited using the Length-Truncated Filter List method, wherein node weights are used to limit the number of items to a maximum number M, as follows for a single-category list. At any given time, the set of relevant candidate items is defined as the set of all candidate items matching at least one document in the document set. When an action occurs that resets the filtering system, the Filter List contains the M relevant candidate items with the highest node weights. If more than one item could be the Mth (based on equal weights), all such item are included, making the list longer than M. An alternate embodiment omits all such infobs, making the list shorter than M, and may be more appropriate if the previous method often results in long lists. If the number of relevant candidate items N≦M, then the M−N candidate items with the highest node weights are also included with their “relevance” attributes set to indicate non-relevance, consistent with standard Filter List behavior. If more than one item could be the (M−N)th (based on equal node weights), no such item is included, making the list shorter than M. (An alternate embodiment includes such items, making the list longer than M.)

When a filter action occurs, one of the following rules will apply in the case of a Length-Truncated Filter List. If, prior to the filter action, N≦M, and if the filter action is one that reduces the size of the document set, the list behaves like a standard Filter List. That is, the set of items remains unchanged and more items may be presented with their “relevance” attributes set to indicate non-relevance, as appropriate. If the above case does not apply and if, after the filter action, N≦M, the (M−N) concepts with the highest node weights that were present in the list prior to the action are retained (with their “relevance” attributes set to indicate non-relevance). If more than one such item could be the (M−N)th, all such items may be included, or all such items may be omitted. If the above cases do not apply and if, after the filter action, the number of relevant candidate items ≧M, the same criteria are used as after a filter-reset action, as described above. A default value for M may be supplied, either globally or on a list-by-list basis. The default value may be determined through usability testing or other methods that aim to find an appropriate balance between availability of items and ease of finding them. The user may be able to override this default value, again either globally or on a list-by-list basis.

The Length-Truncated Filter List method may also be applied to a list with more than one category of candidate object. The method may be applied to each category individually, with a portion of M allotted to each category. Or, it may be applied to all categories in the list together, assuming items in all its categories use the same scale for node weight values. If items in different categories use different scales for their node weight values, the various scales may be normalized, after which the method above may be applied to all categories together. Or, the algorithm may be applied to one or more, but not all, categories in a list. In this case, the number of items in categories for which the algorithm is not used may be subtracted from M, the result of which calculation may be apportioned among the categories to which the method is applied. Alternatively, M may simply be defined without reference to categories excluded from the method and so apportioned.

An alternative to the Length-Truncated Filter List defines a threshold weight instead of a threshold list length. An object is included in the list if and only if its node weight exceeds the threshold. In this case, the length of the list is still limited but may vary.

Another alternative to the Length-Truncated Filter List limits the list contents based on relevance to the current document set, combined with or instead of the weight value. A simple form of such a method is identical to the Length-Truncated Filter List method, except that the number of documents that match a given node in the set of relevant candidate items may be used in addition to or instead of the node weight to determine whether an item is present in the list.

Another, potentially more robust such method is a Combined-Relevance Filter List. This method truncates the list based on both node weights and relevance to the current document set. For a particular category of candidate term, a Combined-Relevance Filter List uses a threshold node weight value T to limit the number of items displayed, as follows. For a candidate term X, we define the raw relevance Rₓ to be a measure of how relevant X is to the current document set. This may be based on the number of documents in the document set that match X; an average or other combination of the association values between X and the documents in the document set; or a combination thereof. We define the maximum raw relevance Rₘₐₓ to be the largest raw relevance R_{N} for any candidate term N. For a candidate term X, we define the relative relevance Fₓ to be Rₓ/Rₘₐₓ. The relative relevance is a measure of how relevant X is to the document set in comparison with other candidate terms. We define P to be the percentage of total documents in the document collection contained in the document set (expressed as a number between 0 and 1). For a candidate term X, we define Wₓ as X's node weight, normalized to a number between 0 and 1 by division by E, the maximum possible node weight value. In this context, the node weight can be thought of as the relative relevance of X when the document set is the document collection, though in reality the node weight may be more informative. For a candidate term X, we define the local weight Lₓ to be an average of Wₓ and Fₓ weighted with respect to P, i.e.:

$$\frac{( {W}_{x} \times C \times P ) + ( {F}_{x} \times ( 1 - P ) )}{( C \times P ) + ( 1 - P )}$$

where C is an empirically determined constant used to adjust the relative weights.

A candidate term X is then included in the list if Lₓ>(T/E). A default value for T may be supplied, either globally or on a list-by-list basis. The default value may be determined empirically based on typical document collections and a target list length determined via the methods described for Length-Truncated Filter Lists above. The user may be able to override this default value, again either globally or on a list-by-list basis. An alternate embodiment uses a maximum length value M, as defined for a Length-Truncated Filter List. The threshold value T is then dynamically adjusted to produce a list of length M.

A Combined-Relevance Filter List, including any foregoing embodiment, may also be applied to a list with more than one category of candidate object. The method above may be applied to each category individually. Or, it may be applied to all categories in the list together, assuming items in all its categories use the same scale for node weight values. If items in different categories use different scales for their weight values, the various scales may be normalized and T defined on a normalized scale, after which the method may be applied to all categories together. Or, the method may be applied to one or more, but not all, categories in a list.

In an embodiment the user may explicitly combine two or more infobs to create a merged infob. The nodes for its constituent objects may be combined in the Connection Layer. Its connections may be combined: If a constituent object has a non-zero connection (i.e. a connection with non-zero weight) to another object to which no other constituent object is connected, that connection may be added to the merged infob as is. If two or more constituent objects have non-zero connections to the same object, a single connection to that object may be added to the merged infob whose connection weight may be the average of the connection weights for all constituent objects with such non-zero connections to that object, possibly combined with an overall increase in value based on the number of constituent objects with such non-zero connections to that object. Other possible methods of calculating this connection weight include a sum, an average, or some other calculation. Any documents assigned to a constituent object may be assigned to the merged infob. In an embodiment where such assignments are weighted, a document assigned to only one constituent object may be assigned to the merged infob with the same assignment weight; a document assigned to multiple constituent objects may be assigned to the merged infob with a weight that is the average of those assignment weights, possibly combined with an overall increase in value based on the number of constituent objects with such assignments. Other possible methods of calculating this assignment weight include a sum, an average, or some other calculation. The merged infob's name may be the name of the constituent object with the highest node weight. Alternatively, it may be a combination of the names of the constituent objects. In an alternate embodiment, the user is prompted to choose a name by selecting from among the names of constituent objects or typing a new name.

To remain synchronized with the Text Engine, the Connection Layer may need to retain much of the information from each constituent object of a merged infob, so that the merged node may be updated with any changes that would normally affect the constituent objects. Such updates may depend on comparing information from the constituent nodes with new or updated infobs in the Text Engine, for example to determine if an infob in the Text Engine corresponds to a constituent object of a merged infob. Such comparison may be accomplished in a number of ways including comparing the number of identical constituent phrases; the number of similar constituent phrases according to a similarity algorithm; or overall similarity according to a similarity algorithm at the object level, with such an algorithm either included as part of the Text Engine or separately in the invention for this purpose. For comparison purposes, it may be advantageous for a merged infob node to store information about its constituent nodes using the same data structure used for actual nodes.

The user may create a merged infob by selecting two or more items in a Filter List and performing an action. In a standard graphical user interface, this action might be performing a secondary click such as a right-click and selecting from a context menu; clicking a button; or executing a menu command with the mouse or keyboard. An embodiment allows the user to merge objects in multiple filter lists.

It is possible to merge folders via the same actions in the user interface as those used to merge infobs. The merging process may be somewhat simpler than that used for merging infobs (particularly as there may not need to be any difference between a normal folder and a merged folder). A new folder may be created with its name, node weight, and connections determined as described previously for merged infobs. It may be assigned to all documents to which a constituent folder was assigned. The constituent folders may then be deleted, along with their assignments to documents.

In an embodiment the user may explicitly delete an infob, removing it from the user interface entirely. This may cause it to be removed from the Connection Layer if one is implemented. However, since the Text Engine may continue to identify the infob, it may be retained in some form (such as its Connection Layer node) in a collection of deleted objects. When the Text Engine is updated, objects it identifies may be compared to objects in this collection. If an object identified by the Text Engine is sufficiently similar to one in this collection, it may be assumed to match the deleted infob and ignored. Such similarity may be calculated in a number of ways including the number of identical constituent phrases; the number of similar constituent phrases according to a similarity algorithm; or overall similarity according to a similarity algorithm at the object level, with such an algorithm either included as part of the Text Engine or separately in the invention for this purpose. If the Text Engine assigns a unique, permanent identifier to each infob, it may be unnecessary to calculate similarity: An object in the collection of deleted objects may be compared to an object identified by the Text Engine using a simple comparison of their unique identifiers.

The user may delete an infob by selecting one or more items in a Filter List and performing an action. In a standard graphical user interface, this action might be performing a secondary click such as a right-click and selecting from a context menu; clicking a button; or executing a menu command with the mouse or keyboard.

An embodiment may have access to one or more address books implemented outside the invention. Some computer operating systems provide a system-wide address book. Most groupware systems provide address book functionality. And address book functionality may also be available via a network address book such as an LDAP server. If no external address book is available, or if one is available but is insufficient (for example, due to a lack of features or intermittent access), an address book may be implemented as part of the invention. If several address books are available, one may be designated (by the system, the user, or both) as a primary address book; the contents of all address books may be synchronized; or the user interface may be augmented to allow user selection of which address book or address books should store a particular entry.

It is likely that a Text Engine will identify numerous people as entities in a large document collection. It is also probable that some of these people will not be of particular interest to the user, will be of passing interest to the user, or will only be of interest to the user in the course of activities involving certain documents. It may thus be advantageous to create two classes of stored people: Contacts, which are people of sufficient ongoing interest to the user to be kept in an address book; and pre-contacts, which are people of insufficient ongoing interest to be contacts. Any person found in one or more address books may be considered to be a contact. Any person identified by the Text Engine but not matched to an address book entry may initially be considered to be a pre-contact. (People identified by the Text Engine may be compared to address book entries via a simple string comparison of the names, or by a more sophisticated method for computing similarity.) A pre-contact may be converted to a contact when the user explicitly chooses to view or edit the pre-contact (as an address book entry); or when the pre-contact's node weight exceeds a threshold value U, whose value may initially be empirically defined but may also be adjustable by the user. A contact may be converted to a pre-contact when the user deletes all address book entries for it and its node weight is below the threshold value U; or when no address book entries exist for it and its node weight drops from a value above U to one below U.

An embodiment that implements its own address book or provides a user interface for an external address book may contain one or more user interfaces that list address book entries. Since address book entries correspond to contacts, only contacts may be presented in such lists. However, one or more such lists may contain an option that enables the display of pre-contacts as well. In an embodiment that implements its own address book or provides a user interface for an external address book, an address book user interface may include a user interface element similar to the Document Sidebar that presents people, documents, and other objects related to a selected address book entry or entries.

People form one category of candidate filter term. An embodiment dedicates a single Filter List to People by default, the People List (11), included in the Main Interface of some embodiments. Candidate terms in this category include both contacts and pre-contacts. An embodiment displays all candidate terms that represent contacts and selects which pre-contact terms to display using the Combined-Relevance Filter List method. A further embodiment allows the user to limit the number of contacts displayed using the Length-Truncated Filter List method. As initially defined, the People List only contains people, and thus the “category” attribute may not be displayed.

In an embodiment, the user can perform an action on selected items in the People List that opens an associated address book entry or entries. The nature of this action may be based on what is appropriate for the environment in which the invention has been implemented. In the case of many graphical user interfaces, a double-click is the appropriate action, as it is associated with “opening” an item.

In an embodiment whose Text Engine extracts sentiment from documents, the Text Engine may be able to extract not only document-level sentiment but also sentiment relative to specific entities, particularly people. For example, an email may represent anger at one person and satisfaction with another. In such an embodiment this information may be presented as a “sentiment” attribute in the People List. In a graphical environment, this attribute may be displayed as one of several icons near the text of each item: A lack of icon (none displayed) might represent neutral sentiment with respect to that person; a red angry face might represent anger; a green happy face might represent satisfaction; and so on. In an embodiment, the “sentiment” attribute reflects overall sentiment in the document set with respect to each item. In an alternate embodiment, it reflects only sentiment in those documents selected in the Document List. In a further alternate embodiment, it reflects overall sentiment in the document set, weighted toward those documents selected in the Document List.

The Concept List (8) is a Filter List that contains concepts, and is included in the Main Interface of some embodiments. It may also contain other categories such as organizations, places, and scheduling infobs (in an embodiment that does not categorize these as concepts). Due to the potentially large number of candidate filter terms, an embodiment limits the length of the Concept List using the Length-Truncated Filter List method, preferring the embodiment of that method wherein a single maximum list length is set for the entire list. Some Text Engines may provide infobs in a hierarchy, with higher-level infobs containing lower-level infobs. In an embodiment that uses such an engine, the Concept List (and perhaps other Filter Lists) may be presented as a hierarchy. In a standard graphical environment, this may be done via a tree control that presents a handle for each item that contains sub-items. Activating the handle (for example, clicking on it) toggles the visibility of the item's sub-items.

The Folder List (12) is a Filter List that contains folders, and is included in the Main Interface of some embodiments. In one embodiment the Folder List contains all folders. Because folders are user-generated and conceptually somewhat different from infobs, an embodiment prevents users from combining folders with another candidate term category in a single Filter List. Since folders are stored in a hierarchy, the Folder List may be presented as a hierarchy (13), as described for the Concept List.

Although the Folder List only contains a single candidate term category, it may be appropriate to retain its “category” attribute. In a graphical environment this attribute may be displayed as an image of a folder (14). While this is technically unnecessary, users of other email systems are familiar with this style of display for folders. In such an embodiment, users may have the option to hide this attribute, and an embodiment hides it by default.

Folders may be conceptually different for the user from other candidate filter terms, sharing much in common with Views. As such, in an embodiment the Folder List departs in its behavior from that of standard Filter Lists: Multiple selected items are combined using the OR operator rather than the AND operator by default. The entire group of OR'ed folder terms can then be combined with other filter terms using AND.

In addition, certain Special Views may interact with folders based in part on user familiarity with preexisting email systems. These include Inbox, Outbox, Sent Messages, and Drafts (alternate names omitted for simplicity). Inbox effectively contains all incoming documents to which a folder has not been assigned. Thus it may often serve as a starting point, and moving from it to a specific folder or folders is a common task. The other Views listed are also unlikely to contain messages assigned to a folder. In an embodiment, when any of the aforementioned Views is selected in the View List and no item is selected in the Folder List, selecting an item in the Folder List changes the View List selection to All Messages prior to selecting the target item in the Folder List.

In addition to or instead of information presented by the “status” attribute, an embodiment of the Folder List may mirror common email systems in using an additional list attribute to indicate the existence of unread documents in a folder. In a graphical environment, this may be accomplished by displaying the item's text in bold (16). In addition, the number of unread documents may be presented, for example as part of the item's text (15).

The user may add, rename, or delete a folder. In a graphical environment, commands to perform these actions may be found in several places including pull-down menus, pop-up menus, contextual menus, and buttons. Renaming a folder may not have an effect on underlying data structures, though the ability to rename a folder may make it appropriate to identify folders in data structures by a unique ID or pointer rather than by name. Deleting a folder may remove it from any documents to which it has been assigned.

The contents of the document set may be represented by a Document List (34), a multi-column list box each of whose items displays one or more fields of information pertaining to the document it represents. A Document List is included in the Main Interface of some embodiments. In one embodiment based on email, the default fields are an Action field (25) combining the Unread tag with data representing actions (such as a reply or forward) taken on the message; the Flagged tag (26); the From message header; the Subject message header; the Date Received or Date Sent message header; the document Urgency (36); and a field representing attachments (35), which may indicate the presence of attachments, the number of attachments, both, or may dynamically change how much data is displayed based on available space.

In an embodiment, the user may change which fields are displayed. Choices may include one or more of: all fields available in structured content (such as message headers); a Folders field containing a list of folders assigned to the document; an attachment field as described above; document Urgency; fields for individual tags; the message size on disk; the Action field described above; a field listing assigned or associated infobs; and a status field combining two or more tags and/or Urgency. In a further embodiment, some fields' data may be represented graphically including the Unread tag, the Flagged tag, the presence of attachments, the Action field, and the document Urgency. Many of these may simply use the presence or absence of a particular image to present their data. Others, such as document Urgency, may use several images to convey a range or collection of possible values. In an embodiment, the user may perform an action (such as a mouse click) on a field that can be changed by the user and uses a discrete set of values (such as the Unread or Flagged tag) to change its value. In a related embodiment, the user may perform an action (such as a mouse click) on a field to initiate a command; for example, performing an action on the Action field when it indicates the presence of a reply to the current message might open the relevant reply or replies in a Document Interface. The document list may allow multiple items to be selected at once.

An embodiment with multiple document types (such as messages and notes or the various document types associated with a groupware or PIM system) may distinguish among document types in the Document List. This may be accomplished via an attribute (such as the “category” attribute used by Filter Lists) or a field in the Document List (such as a Type column).

An embodiment also includes a field containing one or more snippets. Snippets are portions of a document's content, or text summarizing a document's content or a portion thereof (27). In an embodiment, a single snippet is presented containing the first N characters of the document content. In another embodiment, a method used to summarize content is applied to the document to generate one or more snippets. Such algorithms are widely available, and in some cases may be part of a Text Engine. In an embodiment, portions of a document's content are selected as snippets based on the filter set. For example, a portion of a document surrounding a constituent phrase of an infob used as a term in the filter set might be selected as a snippet. Some Text Engines can calculate one or more sections of a document (most relevant passages) that are most relevant to a particular query. One preferred embodiment uses such a Text Engine and uses the most relevant passages to the current filter set as snippets. It may also be that a document summarization algorithm can be provided with terms from the filter set as input and can tailor the resulting summary or summaries to those terms, focusing on portions of the document related to them. Another embodiment uses such a summarization algorithm to provide a snippet or snippets.

In an embodiment, the number of characters used for each document's snippet(s) is limited due to space constraints in a graphical environment, time constraints in an audio environment, or a similar limit in another environment, and also due to the fact that snippets' effectiveness in providing easily-scanned information for a document set may diminish if they are too long. This limit is represented by the value N in the first example above; by the length of a single document summary if that is used; or by the combined length of individual snippets if multiple snippets are used. It may be selected based on the available space in a graphical environment, or an equivalent criterion in another environment; based on a value empirically determined as reasonable for accomplishing the purpose of snippets; or on a combination thereof. It may further be adjusted dynamically in a graphical environment if the available space changes, for example due to a user resizing the user interface or an element thereof. In an embodiment, it may further be adjusted directly by the user. In one graphical embodiment, snippets are displayed in a second row for each item in the Document List, in a field spanning all but the one or two leftmost columns of the item's primary row. If multiple snippets are displayed, the available space may be apportioned among them. Each snippet may be truncated either using a set number of characters or as a function of the algorithm that generates it. Snippets may be separated using ellipses (28), and ellipses may also be used at the beginning or end of a snippet to indicate the existence of more content, provided the beginning or end of the snippet does not coincide with the beginning or end of the document. The user may elect not to include snippets in the Document List.

A document may be manually assigned to a folder through an action linking its item in the Document List with the folder in the Folder List. This may be achieved via a “Move to Folder” or “Add to Folder” command; or, in a graphical environment, by using drag-and-drop to drop the item from the Document List onto the folder in the Folder List. The user may then be presented with the option to retain any other folders assigned to the document or remove other folders assigned to the document. The user may further elect to set a default setting for this option in order to avoid making the choice every time. The invention may further provide secondary actions (for example, dragging while holding down a modifier key) by which the user may explicitly assign the folder and make this retain/remove choice in a single action. If no other folders are assigned to the document, presentation of this option may be omitted.

An embodiment allows the user to view items in the Document List grouped by Conversation. Such an embodiment may initially show a single item for each Conversation, and may allow the user to expand a Conversation and see its constituent documents. A similar technique is employed by several existing email systems to organize messages by “thread,” but the grouping techniques may not be as sophisticated. Apple's Mail.app software provides a fairly effective implementation of this user interface technique, particularly in its use of animation to help the user retain context as groups are expanded and collapsed.

The content of documents selected in the Document List may be presented in a Document Pane (21), included in the Main Interface of some embodiments. The Document Pane is a content box. When one document is selected in the Document List, that document's content may be presented in the Document Pane. When no document is selected in the Document List, the Document Pane may be empty. When multiple documents are selected in the Document List, the Document Pane may be empty in an embodiment; in another, the information presented for those documents in the Document List is also presented in the Document Pane (perhaps in a different format from that used in the Document List). In this latter case, selecting one of these documents in the Document Pane (for example, by clicking) may make it the sole selected item in the Document List. An alternate embodiment presents a message such as, “N messages selected” in the Document Pane when multiple documents are selected in the Document List, where N is the number of documents selected.

The content of a document may be plain text, formatted text, or formatted text with graphics (for example, HTML-formatted email). The Document Pane may present any of these formats or may convert formatted text and graphics to plain text before presenting them. In an embodiment, the Document Pane can present either plain or formatted text but the user can elect to present only plain text, converting formatted text prior to presentation or selecting a plain-text version of the content from among several alternate versions when available. For security reasons, an embodiment does not execute scripts or load remote images embedded in document content, except as explicitly specified by the user either as a global option or on a case-by-case basis.

The content of a document may be entirely unstructured, semi-structured, or fully structured. In the last case the document structure may render the Text Engine and Connection Layer partially or entirely unnecessary. The Document Pane may reflect some or all of the document structure, and may display some or all of the document content. An embodiment for email displays the entire message body (20) along with selected headers (19). The user may change which headers are displayed. When the message body is enclosed in multiple formats (such as an HTML MIME part and a corresponding plain text MIME part), only one version may be displayed, depending on defaults and user preferences. The names of any attached files may also be displayed with the headers, along with a command to open or save each or all of them. Security information, such as whether the message has been signed with a digital signature and whether the message was encrypted, may also be displayed with the headers.

A document may contain words or phrases that correspond to (i.e. are constituent phrases of) infobs. These may be highlighted in some manner, in unstructured and/or structured content. For example, each might be displayed with a box around it and/or a different background color from that of the Document Pane itself (22).

In an embodiment, the user may access a list of commands and additional information related to each of these infobs (hereinafter referred to as an Infob Context List) via the highlighted word or phrase in the document. (In such an embodiment it is advantageous for the highlight to use conventions of the environment in which the invention has been implemented to indicate that such commands and information are available, for example by the use of a bevel effect, an arrowhead, and/or a change in the highlight when the cursor is over the word or phrase.) In a traditional graphical user interface, an Infob Context List may be presented via a popup menu or similar element. It may be appropriate to augment the standard popup menu element in such an environment to accommodate the richer data that may be displayed in this particular case. In another environment, an element similar to a dropdown may be used.

Regardless of the element used, an Infob Context List may contain one or more of the following items:
Several documents listed by one or more of title (subject header in the case of email), author (sender in the case of email), date, or another field, attribute, or portion of document content. These documents may be chosen based on a combination of the strength of their associations with the target infob and the strength of their associations with the current document. The number of documents presented may be determined based on likely available screen space and further limited by a desire to keep the list relatively short. The user may be able to change this number. In an embodiment, a snippet, several snippets, or a portion of one or more snippets may be presented for each item. If the user selects one of these documents (for example, by clicking on it), it may be displayed in a Document Interface.
A command that opens a Document Interface containing all documents that match the target infob.
Other infobs sufficiently associated with the target infob, the current document, or a combination of the two. Selecting one (for example, by clicking on it) may open a Document Interface containing documents sufficiently associated with it, or sufficiently associated with both it and the target infob, the current document, or a combination of the two. Alternatively, selecting such an item may add it to the filter set, or may reset the filter set and then add it. If the Document Pane is part of a Document Interface (which has no filter set), this action may not be available, may affect an available Main Interface, or may create a new Main Interface. Selecting a person may instead open the associated address book entry.
A command that adds the target infob to the filter set. If the Document Pane is part of a Document Interface (which has no filter set), this option may not be available, may affect an available Main Interface, or may create a new Main Interface.

In some environments, such as one using a standard graphical user interface with a pointing device such as a mouse, the action of accessing an Infob Context List via a word or phrase in the document has the potential to conflict with the action of selecting document text. This conflict may be resolved by interpreting a click event over such a word or phrase as an attempt to access the Infob Context List, and a drag event as an attempt to select the text. Note that some selection-related commands available in many such environments, such as double-clicking to select a word, may not work when attempted on such a word or phrase, but regardless can affect such a word or phrase when attempted over non-infob text.

An embodiment also includes a Document Summary Box (not shown in FIG. 2) near the Document Pane. The Document Summary Box includes summary information (such as abbreviated message headers; security information; and document Urgency) about the document and serves as a header for the Document Pane. An embodiment of the Document Summary Box for emails also includes an area with basic information about each file attached to an email; commands to open each attached file individually; and a command to open all attached files.

A further embodiment of the Document Summary Box for email documents also includes information about and links to documents in the same thread or Conversation as the current document, for example messages that are replies to the current document; messages to which the current document is a reply; and messages in any Conversation of which the current document is a part. Since the last case might involve a large number of documents, an embodiment provides summary information about the Conversation and a command (or link) that opens all messages in the Conversation in a separate Document Interface. If no pertinent information exists for a particular area of the Document Summary Box, that area may be omitted. Information in the Document Summary Box may or may not duplicate information found in the header area of the Document Pane.

In an embodiment, the user may create a shell infob—a user-defined infob with no basis in the Text Engine—by selecting text in the Document Pane and performing an action. In a standard graphical user interface, this action might be performing a secondary click such as a right-click and selecting from a context menu; clicking a button; dragging selected text onto a Filter List, such as the Concept List; or executing a menu command with the mouse or keyboard. The action may create a new infob node in the Connection Layer whose name may be the selected text and which has one constituent phrase, the selected text. Its initial node weight may be a neutral value. It may initially be assigned to the document from which it was created and/or any other documents containing its constituent phrase.

A shell infob may initially be connected by non-zero connections to any object assigned to and/or sufficiently associated with a document that contains its constituent phrase (i.e. to which it will be assigned). Such connections' weights may be relatively weak, but may vary based on the number of documents containing the shell infob's constituent phrase to which the connected object is assigned and/or with which the connected object is associated; the assignment weights and/or association values of those assignments and/or associations; the number of such documents; the number of instances of the shell infob's constituent phrase and the connected infob's constituent phrases in each such document; and the distance between instances of the shell object's constituent phrase and the connected infob's constituent phrases, measured in characters, sentences, and/or paragraphs, using a distance measure supplied by the Text Engine, or using a combination of methods. A search of the document collection may also be used to determine connections between the shell infob and other objects, for example using a built-in search facility of the Text Engine.

Once created, a shell infob can behave as does any infob, except for its interaction with the Text Engine. It may be relatively unaffected by the Text Engine, except if the Text Engine identifies its constituent phrase for extraction. In that case the shell infob may be merged with the infob created by the Text Engine. In an embodiment, the shell infob's name is used for the name of the merged infob. The merged infob may still be tracked by the Connection Layer as different from a standard infob: The original shell infob's name may be retained as long as the infob exists; and, if the document collection changes such that a standard infob would be deleted by the Text Engine, the original shell infob may be retained.

An embodiment includes an Attachment List (18), included in the Main Interface of some embodiments. The Attachment List is a list box. It is not a Filter List, though it may have some features in common with one. It may support selection of multiple items. It presents all files attached to any document in the document set. Like a Filter List, it may have a “category” attribute and/or a “status” attribute. The “category” attribute may be used to indicate the type of file, for example by displaying the standard icon for that type of file (1 7). The “status” attribute may be used in a manner similar to the “status” attribute of Filter Lists, i.e. to indicate the presence of a Flagged or Unread tag on the associated document (not shown in FIG. 2). An embodiment includes an “urgency” attribute, used in a manner similar to that described for Filter Lists to indicate the Urgency value of the document to which the attachment corresponds. An alternate embodiment presents such Urgency information via the “status” attribute, again in a manner similar to that described for Filter Lists. An embodiment may use an additional list attribute to indicate those items attached to documents currently selected in the Document List. An alternate embodiment automatically selects such items.

A tool tip for each item in the Attachment List may display additional information about the file, similar or identical to that displayed in the Document Summary Box. In an embodiment, selecting one or more items in the Attachment List selects the corresponding documents in the Document List. Alternatively, selecting one or more items in the Attachment List may have no immediate effect and a further action on the selected items may open the associated file(s). The nature of this action may be based on the environment in which the invention has been implemented. In the case of most graphical user interfaces, a double-click is the appropriate action, as it is associated with “opening” an item. An alternate embodiment eliminates manual selection and opens the file after what would normally be a select action, such as a click. In such an embodiment the items may be displayed as hyperlinks to indicate this.

By default, an embodiment sorts the Attachment List first by file type, then by filename in ascending alphabetical order. Other embodiments may employ other default sort orders. The Attachment List may be implemented as a multi-column list so that the user may re-sort it, particularly by filename as the primary sort. It may be advantageous for the Attachment List to avoid presenting certain types of attachment, such as digital signatures, that may not be considered attachments from the user perspective. It may further be appropriate not to treat such attachments as attachments anywhere in the user interface.

Several filters may be included other than those presented by Filter Lists. An embodiment includes a Text String Filter, whose primary user interface element is a text input box (23). The Text String Filter is included in the Main Interface of some embodiments. The document collection (or, for efficiency, the document set defined by the filter set without this filter) is searched for its text, and only documents matching it are included in the document set. A document matches the text if a search using the text as query returns the document. Such a search may be a straightforward text search, or a more complex search, for example employing fuzzy matching technology. Appropriate search algorithms and tools are widely available. With structured or semi-structured documents such as email, the search may be restricted to a default set of fields. The user may further be able to select one or more fields to which to restrict the search. Such selection may be accomplished via a dropdown or other list-like element (24).

In an embodiment, use of a Submit button is not required to add the content of the Text String Filter to the filter set; instead, it is added as the user types. Rather than add the input to the filter set after each character is entered, however, it may be advantageous to add it only when the user pauses for a period of time. In an embodiment, filter sets generated as the user modifies the text of the Text String Filter are considered interim filter sets and are not stored in the filter set history used by the Go Back and Go Forward functions. A normal, non-interim filter set may only be stored when the user moves to some other activity. (The user may be considered to have moved to another activity given a pause of sufficient length, however.) If an element is used to restrict the input to a field or fields, its selection may be updated in the filter set as soon as it is made. In a further embodiment, when the text input box is empty its selection is not updated in the filter set until the text input box is non-empty.

In an embodiment, the Text String Filter includes an auto complete feature: As the user types, previously entered items that begin with the text typed so far are presented and may be selected, for example, in a list below the text input box. The history information required for auto complete may be stored for a default period of time, or indefinitely. The default period may be altered by the user, or set to 0 to disable auto complete altogether. An embodiment allows the user to enable or disable auto complete via a user interface element that presents a binary choice, such as a checkbox.

An embodiment includes a command that clears the current filter set (removing all terms except the View) and then places the text currently selected in the Document Pane into the Text String Filter.

An embodiment has an Urgency Filter which allows the user to choose an Urgency value. The Urgency Filter is included in the Main Interface of some embodiments. A document matches the Urgency Filter if its Urgency value is greater than or equal to the filter's value. In an alternate embodiment, a document matches the filter if it equals the filter's value. In a further alternate embodiment, the user may choose between these exact and range matching options.

An embodiment of the Urgency Filter uses a dropdown with text equivalents for various Urgency values, such as “Very Urgent” and “Not Urgent” (32). Another embodiment uses a user interface element capable of defining a range, such as a slider control in a graphical user interface, with one end of the slider representing low Urgency and the other high Urgency. In an embodiment of this, the filter set is updated dynamically as the user drags the slider (or perhaps whenever the user pauses dragging for a sufficient length of time), though it may be that this is not feasible for performance reasons. In such an embodiment, filter sets generated as this control's value is adjusted may be considered interim filter sets as described above.

An embodiment includes a Date Filter, which allows the user to choose a date or date range. The Date Filter is included in the Main Interface of some embodiments. In the case of a single date, a document matches the Date Filter if and only if the document's filtering date is the same as that specified by the filter. In the case of a date range, a document matches the Date Filter if and only if its filtering date falls within the range specified by the filter. A document's filtering date is the date associated with the document that is most appropriate to the filtering process. In the case of email, the filtering date may be the date the message was sent. In an embodiment, a dropdown is used containing text phrases corresponding to date ranges, such as “this week,” “today,” or “last 30 days” (33). In an embodiment the user can customize these values.

An alternate embodiment of the Date Filter uses a user interface element capable of defining a range, such as a slider control in a graphical user interface, with one end of the slider representing the current date and time and the other representing the earliest date in the document collection. A further alternate embodiment uses a user interface element capable of defining both ends of a range, such as a double-ended slider control in a graphical user interface. Double-ended sliders are not part of most traditional graphical interfaces but are available as custom controls from various vendors. If a range-based user interface element is used, its interaction with the filter set may be as described for the Urgency Filter.

In an embodiment, each filter set is retained between sessions (i.e. between when the user exits the system and when he or she next uses it), as are the states of most user interface elements. For example, a Filter List may retain the position of its scrollbar, the items selected (with the exception of any that are no longer available), and/or (if applicable) which items' sub-items are presented; and the Urgency Filter and Date Filter may retain their selections. An alternate embodiment resets the filter set to a default or user-specified start View (such as Inbox) and resets the state of all elements to their initial values. A further alternate embodiment allows the user to choose between these behaviors. A further alternate embodiment resets some elements and aspects of the system while retaining others, and/or allows the user precise control over which aspects of the system are retained.

The invention's filtering process may be viewed as a series of states, each defined by a filter set. Each filter action moves the system from one state to another. A user may wish to return to an earlier state, either to retrace his steps or due to an error. Thus, an embodiment includes Go Back (29) and Go Forward (30) commands that step through the history of states. These commands may be included in any user interface that contains a filter set and/or a document set. This functionality can augment a more traditional Undo command to provide a great deal of flexibility and recoverability from mistakes. Note that moving to a previously-viewed state guarantees the same filter set, but not necessarily the same document set since the document collection may have changed.

An embodiment has a Clear Filters command that clears the filter set of everything but the selected View. An embodiment has a command that clears the filter set and selects the Inbox or All Messages View. It may be labeled Home or Inbox and may be denoted by an image of a house (31). This command may be used instead of or in addition to the Clear Filters command. In a further embodiment, this command is given greater prominence than the Clear Filters command. Either or both of the two aforementioned commands may be included in any user interface with a filter set.

An embodiment includes a Document Interface (FIG. 3). The Document Interface is designed to focus on a small document set without providing filtering functionality. Its projected uses are to examine a document or a small group of documents in greater detail; and to view (for comparison or reference) one document while viewing or composing another, since in a graphical environment a Document Interface may be positioned for viewing alongside another user interface. A Document Interface may include a Document Pane (FIG. 3.21) identical to that found in the Main Interface; a Document List (34) identical to that found in the Main Interface; and a Document Sidebar (41). In an embodiment, the presence of a Document List is dependent on the document set: If its size is 1, no Document List is displayed, while a Document List is displayed if its size is greater than 1.

Since multiple Document Interfaces may be presented simultaneously, actions that result in the display of a document set in a Document Interface when a Document Interface is already open may either add that document set to the document set of an open Document Interface, or open a new Document Interface. By default, an embodiment opens a new Document Interface in this situation. A further embodiment allows the user to override this default.

An embodiment allows the user to elect to eliminate multi-document Document Interfaces altogether. In this case, when an action occurs that would otherwise result in a document set of size N being presented in a multi-document Document Interface, the document set is split into N document sets of size I and each is presented in a separate Document Interface.

The Document Sidebar (41) displays information related to the document(s) displayed in the Document Pane of a Document Interface. Related items may be candidate filter terms, infobs, folders, objects in the Connection Layer, or documents, and may be divided into categories (as shown by the two groups indicated by 42). The number of categories and the number of items per category may vary across embodiments, but it may be beneficial to present few enough that they may be easily scanned by the user. Items may be chosen for inclusion based on the strength of their associations with the document. An embodiment uses approximately 4 items per category for approximately 4 categories, for example people, concepts, documents, and scheduling infobs. In a graphical environment, categories may be separated and/or delineated using headers and/or icons (44). Scheduling infobs whose date and time are sufficiently immediate may be highlighted in some manner (43) to indicate that immediacy.

Each item in the Document Sidebar may have an action associated with it. In an embodiment, each item is displayed as a hyperlink (40) and the action is initiated by clicking on it. For some candidate filter terms (such as concepts, people, and organizations), the action may be resetting the filter set of either the most recently-used Main Interface or the Main Interface from which the Document Interface was generated (if available), and then adding the selected term to the filter set; or the action may be adding the selected term to that filter set without first resetting it. For a person, the action may instead be to open the appropriate address book entry or entries. For a document, the action may be to open the document, either in the current Document Interface or in a new Document Interface.

As noted above, user interface elements may include a facility for resizing, minimizing, and/or hiding them. The Document Sidebar, in particular, may benefit from resize and minimize facilities to benefit users with limited available screen space. An embodiment includes a Document Sidebar in the Main Interface as well.

An embodiment includes a Compose Interface, with which the user creates a new document or edits an existing document or draft. In an email-based embodiment this user interface resembles composition interfaces in existing email systems, such as Apple's Mail.app, Mozilla Thunderbird, Microsoft Outlook, Lotus Notes, or Microsoft Outlook Express. An embodiment includes auto complete of addresses using contacts and pre-contacts; selection from among a group of stored email signatures; facilities for digitally signing and encrypting messages; and plain text and HTML composition tools.

The Compose Interface may be enhanced by highlighting words and phrases corresponding to infobs, as described for the Document Pane. Highlights may be adjusted as the user types, with adjustments occurring continuously, at defined intervals, or when the user pauses typing. Because the document text in the Compose Interface is being actively edited by the user, it may be necessary to further de-emphasize the action that presents an Infob Context List and to further emphasize editing commands for the associated word or phrase. For example, the former action might only be recognized when the mouse button is held down without significant cursor motion for a short period of time. It may be appropriate to make such a change for the Compose Interface only, or to use such behavior system-wide.

Infob highlights and Infob Context Lists may be presented in any header fields provided by the Compose Interface as well as in the main document content. The Compose Interface may be enhanced by the inclusion of a Document Sidebar. Updates to the Document Sidebar may occur continuously, at defined intervals, or when the user pauses typing. In an embodiment involving a mix of document types (such as emails and notes), the Compose Interface may hide or disable some of its elements as appropriate to the document type.

An embodiment includes mail rules. This feature is provided in some form by many traditional email systems, but the invention augments its functionality to make it more powerful and adaptive. A mail rule is a rule applied to a document. It contains a Boolean condition and one or more actions. When a rule is applied to a particular document and its condition evaluates to true for that document, the actions are performed on that document. A rule's condition may be composed of one or more sub-conditions, combined via Boolean operators (AND, OR, NOT). In an embodiment, a different operator may be used for each sub-condition. In another embodiment, a single operator is used across all sub-conditions. In another embodiment, a different operator may be used for each sub-condition in rules managed by the system, but one operator is used across all sub-conditions in rules managed by the user. In a further embodiment, a sub-condition may itself consist of one or more sub-conditions. In one such embodiment, a different operator may be used for each such sub-condition.

Many actions may be available for a mail rule. These include assigning a folder to the document; assigning a label or color to the document (each of which may be stored with other document data—see FIG. 1, 120—and either or both of which may be included in the Document List and/or Document Pane of an embodiment); assigning a tag (such as Flagged) to the document; marking the document for deletion; changing the document's Urgency; running a custom script; playing a sound or displaying a message; or, in the case of an email, routing the message to another recipient or bouncing it back to the sender. A rule may have multiple actions. In an embodiment, the user is prevented from adding an action to a rule when the new action would conflict in some way with an existing action.

Mail rules may be applied when a document is added to the document collection. In the case of email documents, a mail rule may apply to an incoming message when it arrives, to an outgoing message when it is sent, or both. An embodiment also provides a command that lets the user manually apply all active mail rules to documents selected in a Document List. Applying a mail rule to a document may only result in application of the rule's actions when the condition evaluates to true.

The foregoing description of mail rules is consistent with the mail rule functionality found in most popular email systems. Embodiments of the present invention augment this functionality, defining several types of mail rule as well as additional functionality.

Manual Rules function like mail rules in traditional email systems. The user creates sub-conditions and actions, and the rule is applied to incoming or outgoing documents.

Adaptive Rules initially function like Manual Rules. The user creates an Adaptive Rule as he or she would a Manual Rule, but designates it as Adaptive by enabling an option in the user interface. Once created, Adaptive Rules are automatically adjusted based on changes in the Connection Layer and/or changes in associations between objects. For example, suppose, in an email system, that a rule assigns Folder A to all messages from Person A, i.e. “if [message is from Person A] then [assign Folder A]”. Suppose that, over time, the connection weight between Person A and Person B increases so that the two are now strongly associated. The invention may then add another sub-condition to the Adaptive Rule, i.e. updating it to “if [message is from Person A] or [message is from Person B] then [assign Folder A]”. An embodiment may also remove sub-conditions (but perhaps not user-defined sub-conditions) from an Adaptive Rule via a similar process.

Automatic Rules function in a similar manner to Adaptive Rules but don't require user setup. They may rely primarily on associations and/or connection weights in the Connection Layer. For example, if no existing rule assigns a folder to documents from Person A, and if the association between Person A and Folder A becomes strong enough, an Automatic Rule may be created that assigns Folder A to messages from (or perhaps strongly associated with) Person A. As with an Adaptive Rule, conditions and actions in an Automatic Rule may be modified by the system after the rule has been created in response to changes in the Connection Layer or other changes in the associations between objects and documents. If, after such modification occurs, no conditions or actions remain, the rule may be deleted.

An embodiment provides an order of precedence for mail rules, and may give Manual Rules precedence over Adaptive Rules and Adaptive Rules precedence over Automatic Rules. This order prevents rules generated or updated by the system from counteracting rules explicitly defined by the user. Other orders of precedence are possible. In an embodiment, the user can delete Automatic Rules. Such actions affect connection weights in the Connection Layer accordingly. An embodiment may contain all three types of mail rule (Manual, Adaptive, and Automatic), or may contain only one or two types. An embodiment may permit the user to enable or disable one or more types of mail rule.

Many mail systems in use today, such as Apple's Mail.app, Microsoft Outlook, Microsoft Outlook Express, and Mozilla Thunderbird, include user interfaces for managing and editing mail rules. Such user interfaces typically have two parts: A Mail Rule Management Interface that lists mail rules and allows addition, deletion, and perusal of rules; and a Mail Rule Edit Interface that permits modification or creation of a single mail rule. The former generally presents a list of existing mail rules, perhaps with some summary information for each, along with commands that operate on a selected rule or rules. The latter generally allows selection or creation of sub-conditions and actions, with options for each.

Most such interfaces tend to be similar and are sufficient for use here, with the following additions:
The Mail Rule Management Interface may only present Manual and Adaptive Rules by default. An option may be included to present Automated Rules as well. If the user edits an Automated Rule it may be converted to an Adaptive Rule.
The Mail Rule Management Interface may present a modification date for each rule listed, and may further use a multi-column list box to list rules. This allows the user to sort the list of rules by modification date and, in so doing, to see which rules have changed recently. In a further embodiment,'the Mail Rule Management Interface may present a last-applied date (the date on which the rule's condition last evaluated to true for a document) for each rule, allowing the user to monitor and troubleshoot rule behavior more effectively.
The Mail Rule Edit Interface may include an option that specifies whether the rule is Manual or Adaptive, as noted above.

An embodiment provides an option (most likely as part of an interface to specify system-wide user preferences, outside the mail rule user interfaces) to notify the user whenever a change is made to an Adaptive or Automatic Rule. An embodiment disables this option by default.

An embodiment may include or interoperate with one or more third party products for managing junk mail (spam); however, even without such a tool, the mail rules feature can provide some automated junk mail management functionality by virtue of its adaptive nature. As in other email systems, a user may create a mail rule that deletes messages or places them in a junk mail folder based on certain criteria. If such a rule is made an Adaptive Rule, its functionality may improve over time as it identifies other aspects of junk mail documents, adds them to the Adaptive Rule, and deletes or files those documents accordingly. An embodiment that includes Automatic Rules may identify common aspects of junk mail documents that the user deletes or places in a junk mail folder manually, and by generating or updating its Automatic Rules can start to take those actions on the user's behalf.

An embodiment may further support the use of mail rules in managing junk mail by including a Junk tag and associated Junk View (consisting of all documents to which the Junk tag has been assigned), which may be a Special View. An embodiment may include one or more predefined mail rules for managing junk mail, whose action may be to assign the Deleted tag, the Junk tag, or a predefined junk mail folder to a document.

An embodiment includes Report functionality. Reports allow the user to capture a document set in a format suitable for printing, importing into another program such as a spreadsheet or database, or visual scanning for important content. A report relies on a document set. Once a document set is specified, all reports may be equivalent; however, several types of report may be defined that differ in how the document set is determined.

An Object Report is a report whose document set consists of all documents that match a single candidate filter term. An Object Report may be initiated by performing an action on an appropriate object such as an item in a Filter List. For example, in a standard graphical environment the user might perform a secondary click (such as a right-click or a click while pressing a modifier key) on an item in a Filter List to produce a contextual menu, then select a command from that menu. Or, the user might select an item in a Filter List and then initiate the report by selecting a command from a menu.

An embodiment extends Object Reports to cover multiple selections in a Filter List: If several items are selected in a Filter List when an Object Report is initiated, the report's document set is the document set produced by the filter set composed of all selected items in the Filter List. A further embodiment extends this functionality to cover selections in multiple Filter Lists.

A Document Set Report is a report whose document set is the document set of the interface from which the report is initiated. A Document Set Report might be initiated by performing an action included in or applied to a user interface, for example via a toolbar button or menu command.

A report may be generated immediately after the command that initiates it. The report may be stored to disk, for example as a PDF file, and may further be opened in an appropriate application. Alternatively, the report may be presented in a separate Report Result Interface from which the user may save it to a variety of file formats.

In an embodiment, a Report Options Interface is presented after the command initiating the report but prior to generation of the report. The Report Options Interface is a user interface that allows the user to set a number of options that affect the final report, including:
An option to include a summary for each document, generated by an automatic summarization algorithm. It may further be possible to tailor the summary to the document set overall or to the filter set that generated the document set.
An option to select how much of the document content is included in the report. Values may include the full text of the document; text relevant to the document set overall or to the filter set that generated the document set; or no text. An alternate embodiment combines this option with the previous one.
In an embodiment involving semi-structured or structured documents, an option to select which document fields (such as message headers) are included in the report. Individual fields may be listed for selection. In one email-based embodiment, several predefined values are presented: “none”, resulting in the inclusion of no headers; “compact”, resulting in the inclusion of several important headers such as Subject, From, To, CC, and Date; and “full”, resulting in the inclusion of all headers. Such an embodiment may further provide a “custom” value, which presents a user interface allowing the user to select specific fields for inclusion.
In an embodiment involving email, an option to omit any document sent to a person included as a term in the filter set that generated the document set when that document includes no other reference to the person. The option may present the name of each such person for clarity. This allows the user to generate a report containing documents sent by or mentioning one or more people, but not documents merely sent to those people.
An option to select from among several predefined report layouts. Values might include “compact”, which displays summaries and fields at a normal font size but uses a smaller font size, tighter line spacing, and other text attributes to reduce the space taken up by document content; and “regular”, which either uses the same text attributes for everything or uses attributes less significantly different for document content.
An option to select a destination and/or file format for the report. Values may include printing the report and a number of file formats such as PDF, HTML, Microsoft Word, OpenOffice.org Writer, HTML, XML, Microsoft Excel, OpenOffice.Org Calc, tab-delimited text, comma-delimited text, and SQL. Some of these formats render some of the foregoing options irrelevant, and an embodiment disables such options when a format is selected.

As stated previously, this description focuses particularly on the application of the invention to email. Email is often included in larger groupware and/or personal information management (PIM) systems. One embodiment of the invention is as a plug-in for such a system; another embodiment is as such a system. In any such embodiment, document types include not only communications and notes but also calendar events, tasks, and other information. These document types naturally interrelate, and most groupware systems recognize this: For example, some groupware systems attempt to identify a meeting request in the body of an email and generate a corresponding calendar event. The invention can easily be used to take advantage of the interconnectedness of a groupware system and increase its power. For instance, The Text Engine and/or Connection Layer can make identification of meeting requests more accurate and richer, extracting both more accurate and more extensive information with which to generate a calendar event including date and time, attendees, topic, and location.

Filtering can also increase the visibility of relevant tasks and events without requiring the user to view a particular part of a calendar or look through a long task list; allow quick identification and location of important tasks and events; and bring tasks and events particularly relevant to a particular set of messages, or messages particularly relevant to a meeting or task to the user's attention. Features like the Document Sidebar, Filter Lists, and the Infob Context List can bring events and tasks pertinent to a particular document or document set to the user's attention. In all cases, the tools used to manage a large amount of email can be integrated into the other document types in a groupware suite without extensive redesign to bring the same benefits to those document types.

With or without full-fledged groupware/PIM support, proper recognition of schedule infobs is included in an embodiment. The Text Engine may recognize schedule-related phrases such as “Wednesday at 2 pm,” and may parse them to generate actual date information. Or, the parsing step may be implemented outside the Text Engine. Many development environments include functionality to convert strings representing dates into data structures representing dates, and such algorithms may be implemented, used, or purchased as needed. Once a date is converted to a data structure it may be compared to the document creation date, modification date, and/or date sent, to convert a relative string such as “Wednesday at 2pm” to an exact date.

An embodiment may further use the presence of certain infobs—for example, phrases pertaining to meetings—to help trigger specific functionality, such as a meeting request. In an embodiment that includes groupware/PIM functionality, this can then (with or without user interaction) be used to create a calendar event. In an embodiment that does not include groupware, some integration with other groupware systems (through inter-application scripting) may be used. In another embodiment, a collection of automatically-generated events may be maintained to allow their display in features such as a Document Sidebar or an Infob Context List, even if such information is not used for more complete calendar functionality.

While many of the embodiments described herein focus on the invention's use with communication documents in the context of an email management or groupware/PIM system, other applications are clearly possible. One potential use of the invention is in doing research across a large collection of documents, particularly when little enough is known about the content of the collection that a search query is difficult or impossible to construct effectively, or is likely to miss critical information. For example, the user may suspect that some information of interest exists, but may not know the exact topic(s) of interest. In such a situation, the invention's functionality would be helpful, with the possible exception of those functions specific to an active, growing collection of documents.

Such applications include: legal research, wherein a legal firm may need to find relevant information to a case in a large collection of documents (potentially of many types); monitoring of corporate communications, wherein a corporate IT department may need to keep an eye on incoming and outgoing employee communications, or may need to investigate a particular incident with limited information; and security activities such as counter-terrorism, wherein a user is looking for suspicious content in a large document collection. In these cases, a user restricted to a simple query-response method is responsible for creating a good query and may miss topics that would be immediately obvious were he presented with those topics as candidate terms, in the manner described herein. Tools do already exist that use something akin to a Text Engine, combined with a visualization interface, to address this; however, the invention's simple, list-based interface combined with its emphasis on relationships may provide a more powerful, effective, and/or efficient tool.

Another potential use of the invention is as a method for finding content on a user's computer. A number of desktop search tools exist to address this, but suffer from the limitations already discussed for search tools. The invention can allow access by concept, file metadata (including creation date, modification date, author, file size, file type, and specialized metadata available for certain file types such as images or music) and by other infob types to provide an alternative to both a hierarchical file system and the query-response method inherent in search. As the amount of metadata available for certain types of file increases, the invention's application may increase in power and usefulness.

Embodiments of the invention may be implemented in any conventional computer programming language. For example, preferred embodiments may be implemented in a procedural programming language (e.g., “C”) or an object oriented programming language (e.g., “C++”). Alternative embodiments of the invention may be implemented as pre-programmed hardware elements, other related components, or as a combination of hardware and software components.

Embodiments can be implemented as a computer program product for use with a computer system. Such embodiment may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or analog communications lines) or a medium implemented with wireless techniques (e.g., microwave, infrared or other transmission techniques). The series of computer instructions embodies all or part of the functionality previously described herein with respect to the system. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software (e.g., a computer program product).

Although various exemplary embodiments of the invention have been disclosed, it should be apparent to those skilled in the art that various changes and modifications can be made which will achieve some of the advantages of the invention without departing from the true scope of the invention.

What is claimed is:

1. A method of managing a collection of documents, the method comprising:
providing a user interface to manage a collection of documents;
for each document in the collection, identifying at least one information object representative of conceptual content of a portion of the document;
combining the information objects with additional conceptual information inferred from the user interface to determine a network of conceptual relationships associated with the collection of documents;
with the user interface, providing user access to the network of conceptual relationships for management of the collection of documents.

2. A method according to claim 1, wherein the collection of documents includes at least one partially structured document.

3. A method according to claim 1, wherein the conceptual relationships include weights representative of relative relationships between the information objects.

4. A method according to claim 3, further comprising:
using the weights to filter the collection of documents.

5. A method according to claim 3, further comprising:
using the weights to sort the collection of documents.

6. A method according to claim 1, further comprising:
using the network of conceptual relationships to filter the collection of documents.

7. A method according to claim 1, further comprising:
using the network of conceptual relationships to sort the collection of documents.

8. A method according to claim 1, further comprising:
displaying on the user interface a document list identifying the documents in the collection; and
displaying on the user interface a list identifying the information objects.

9. A method according to claim 8, wherein the list is a concept list.

10. A method according to claim 8, further comprising:
providing access to the network of conceptual relationships for filtering.

11. A method according to claim 8, further comprising:
displaying on the user interface at least a portion of one of the documents in the collection including highlighting at least a portion of the document associated with an information object.

12. A method according to claim 11, wherein the highlighting is interactive to allow user access to content related to the highlighted portion of the document.

13. A method according to claim 1, wherein the conceptual content includes at least one of scheduling concepts, task management concepts, and concepts related to personal information management activities.

14. A method according to claim 1, wherein the conceptual content includes proper names or entities.

15. A method according to claim 1, wherein the documents include email messages.

16. A method according to claim 1 wherein the identifying of at least one information object representative of conceptual content of a portion of the document is based on use of text mining.

17. A method according to claim 1, further comprising:
updating the network of conceptual relationships when the number of documents in the collection of documents changes.

18. A method according to claim 1, further comprising:
updating the network of conceptual relationships when the content of one or more documents in the collection changes.

19. A method according to claim 1, further comprising:
updating the network of conceptual relationships in response to one or more user actions.

20. A document management user interface comprising:
means for providing a user interface to manage a collection of documents;
means for identifying for each document in the collection, at least one information object representative of conceptual content of a portion of the document;
means for combining the information objects with additional conceptual information inferred from the user interface to determine a network of conceptual relationships associated with the collection of documents;
means for providing with the user interface, user access to the network of conceptual relationships for management of the collection of documents.

21. A document management user interface according to claim 20, wherein the collection of documents includes at least one partially structured document.

22. A document management user interface according to claim 20, wherein the conceptual relationships include weights representative of relative relationships between the information objects.

23. A document management user interface according to claim 22, further comprising: means for using the weights to filter the collection of documents.

24. A document management user interface according to claim 22, further comprising: means for using the weights to sort the collection of documents.

25. A document management user interface according to claim 20, further comprising:
means for using the network of conceptual relationships to filter the collection of documents.

26. A document management user interface according to claim 20, further comprising:
means for using the network of conceptual relationships to sort the collection of documents.

27. A document management user interface according to claim 20, further comprising:
means for displaying on the user interface a document list identifying the documents in the collection; and
means for displaying on the user interface a list identifying the information objects.

28. A document management user interface according to claim 28, wherein the list is a concept list.

29. A document management user interface according to claim 28, further comprising: providing access to the network of conceptual relationships for filtering.

30. A document management user interface according to claim 28, further comprising:
means for displaying on the user interface at least a portion of one of the documents in the collection including highlighting at least a portion of the document associated with an information object.

31. A document management user interface according to claim 30, wherein the highlighting is interactive to allow user access to content related to the highlighted portion of the document.

32. A document management user interface according to claim 20, wherein the conceptual content includes at least one of scheduling concepts, task management concepts, and concepts related to personal information management activities.

33. A document management user interface according to claim 20, wherein the conceptual content includes proper names or entities.

34. A document management user interface according to claim 20, wherein the documents include email messages.

35. A document management user interface according to claim 20 wherein the means for identifying at least one information object representative of conceptual content of a portion of the document is based on use of text mining.

36. A document management user interface according to claim 20, further comprising:
means for updating the network of conceptual relationships when the number of documents in the collection of documents changes.

37. A document management user interface according to claim 20, further comprising:
means for updating the network of conceptual relationships when the content of one or more documents in the collection changes.

38. A document management user interface according to claim 20, further comprising:
means for updating the network of conceptual relationships in response to one or more user actions.
